(19) United States
(12) Patent Application Publication
(10) Pub. No.: US 2025/0259466 A1
(43) Pub. Date: Aug. 14, 2025

(54) IMAGE PROCESSING METHOD, IMAGE PROCESSING APPARATUS, ELECTRONIC DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventor: Hui GUO, Shenzhen (CN)

(21) Appl. No.: 19/193,241

(22) Filed: Apr. 29, 2025

Related U.S. Application Data
(63) Continuation of application No. PCT/CN2024/073441, filed on Jan. 22, 2024.

(30) Foreign Application Priority Data
Apr. 4, 2023 (CN) 202310399237.0

(51) Int. Cl. G06V 30/19; G06T 5/70; G06V 10/74; G06V 30/18

(52) U.S. Cl. CPC G06V 30/19093; G06T 5/70; G06V 10/761; G06V 30/18; G06V 30/19173; G06V 30/1918

(57) ABSTRACT

This application provides an image processing method and apparatus, an electronic device, and a computer-readable storage medium. The method includes receiving a prompt that needs to be processed; obtaining a text feature of the prompt, and mapping the text feature to a generability index and a description type of the prompt; in response to the generability index being greater than an index threshold, the description type representing that the prompt does not comprise a verb, and the prompt comprising a plurality of clauses, obtaining similar images respectively corresponding to the plurality of clauses, image-text similarities between the clauses and the corresponding similar images being greater than an image-text similarity threshold; determining an image difference between the similar images respectively corresponding to the plurality of clauses; and in response to the image difference being less than an image difference threshold, using the similar images as illustrations of the corresponding clauses.

### RELATED APPLICATIONS

This application is a continuation of PCT Application No. PCT/CN2024/073441, filed on Jan. 22, 2024, which claims priority to Chinese Patent Application No. 2023103992370, filed on Apr. 4, 2023, which are both incorporated herein by reference in their entirety.

### FIELD OF THE TECHNOLOGY

This application relates to image processing technologies, and in particular, to an image processing method, an image processing apparatus, an electronic device, and a computer-readable storage medium.

### BACKGROUND OF THE DISCLOSURE

When implementing certain tasks of generating images based on texts, a user provides a text that the user wants to describe as a prompt. The prompt can be, for example, a plot text or a martial arts novel text. A plurality of plot images are correspondingly generated based on prompts by calling an image generation model, and the plurality of plot images are used as illustrations of the prompts. However, such a method of directly generating an image based on a prompt is prone to having a poor effect of a finally generated illustration.

Descriptive content of a prompt inputted by a user may be abstract. For example, the descriptive content may be various and complex actions, but it may be difficult to perfectly embody the actions in an image, resulting in a low matching degree between a generated image and the prompt. In addition, a sentence of a prompt provided by a user may include many clauses, and the clauses may describe different elements and different content. Therefore, a plurality of generated images with completely different content may be generated based on the same prompt including a plurality of clauses. The generated images are greatly different from each other, may miss a generation element, and are not appropriate for being used as an illustration of the prompt, which consequently negatively affects the correlation of an overall generation effect of the generated images.

### SUMMARY

Embodiments of this application provide an image processing method and apparatus, an electronic device, a computer-readable storage medium, and a computer program product, to improve an overall image-text correlation by performing generability recognition on a prompt in a text-to-image generation scenario.

The technical solutions in the embodiments of this application are implemented as follows:

An embodiment of this application provides an image processing method, performed by an electronic device. The method includes receiving a prompt that needs to be processed; obtaining a text feature of the prompt that needs to be processed, and mapping the text feature to a generability index and a description type of the prompt that needs to be processed, the generability index representing a score of an illustration being generable from the prompt that needs to be processed; in response to the generability index being greater than an index threshold, the description type representing that the prompt that needs to be processed does not comprise a verb, and the prompt that needs to be processed comprising a plurality of clauses, obtaining similar images respectively corresponding to the plurality of clauses, image-text similarities between the clauses and the corresponding similar images being greater than an image-text similarity threshold; determining an image difference between the similar images respectively corresponding to the plurality of clauses; and in response to the image difference being less than an image difference threshold, using the similar images respectively corresponding to the plurality of clauses as illustrations of the corresponding clauses.

An embodiment of this application provides an electronic device, including a memory, configured to store computer-executable instructions or a computer program; and a processor, configured to implement, when executing the computer-executable instructions or the computer program stored in the memory, the image processing method provided in the embodiments of this application.

An embodiment of this application provides a non-transitory computer-readable storage medium, having computer-executable instructions or a computer program stored therein, the computer-executable instructions or the computer program, when executed by a processor, implementing the image processing method provided in the embodiments of this application.

The embodiments of this application have the following beneficial effects:

A generability index of a prompt is determined, the generability index being a score of an illustration being generable from the prompt, determination can be performed with reference to the generability index and a description type of the prompt, so that it can be recognized whether the prompt includes a verb and whether the prompt is appropriate for illustration generation, and related processing can be performed on the prompt based on a recognition result. The prompt is checked from dimensions such as generability and a description type, thereby avoiding a case that quality of a generated illustration is poor because the prompt does not meet a processing condition for text-to-image generation. Similar images of clauses in the prompt are determined respectively, an image difference of a similar image of each clause is evaluated, to sift illustrations of a plurality of clauses in the prompt. Based on image selection for a prompt, more targeted fine-grained image selection is implemented for clauses of the prompt, thereby improving an overall correlation of a generated image corresponding to the prompt.

### BRIEF DESCRIPTION OF THE DRAWINGS

FIG. 1 is a schematic structural diagram of an architecture of an image processing system according to an embodiment of this application.

FIG. 2 is a schematic structural diagram of an electronic device according to an embodiment of this application.

FIG. 3A to FIG. 3K are schematic flowcharts of an image processing method according to an embodiment of this application.

FIG. 4 is a schematic diagram of a closed-loop system for generating consecutive illustrations according to an embodiment of this application.

FIG. 5 is a diagram of image generation based on an original sentence according to an embodiment of this application.

FIG. 6 is a sequence diagram of secondary image generation after sentence splitting according to an embodiment of this application.

FIG. 7 is a schematic diagram of an original generated image sequence according to an embodiment of this application.

FIG. 8 is a schematic diagram of sequence-associated generated images according to an embodiment of this application.

FIG. 9 is an diagram of an architecture of an image generation model according to an embodiment of this application.

FIG. 10 is a diagram of a process of evaluating a correlation of a generated image according to an embodiment of this application.

FIG. 11 is a schematic diagram of evaluating a sequence correlation of generated images according to an embodiment of this application.

FIG. 12 is a diagram of a process of recognizing a sentence whose generation result is inappropriate according to an embodiment of this application.

FIG. 13 is a diagram of determining a difference between generated images according to an embodiment of this application.

### DESCRIPTION OF EMBODIMENTS

To make the objectives, technical solutions, and advantages of this application clearer, the following further describes this application in detail with reference to the accompanying drawings. The described embodiments are not to be regarded as limitations on this application. All other embodiments obtained by a person of ordinary skill in the art without creative efforts shall fall within the protection scope of this application.

In the following descriptions, the term “some embodiments” describes subsets of all possible embodiments, but “some embodiments” may be the same subset or different subsets of all the possible embodiments, and can be combined with each other without conflict.

In the embodiments of this application, related data, such as user information, may be involved. In a case that the embodiments of this application are applied to a specific product or technology, a permission or an approval from a user needs to be obtained. In addition, collection, use, and processing of the related data need to comply with relevant laws, regulations, and standards of relevant countries and regions.

In the following descriptions, the included term “first/second/third” is merely intended to distinguish similar objects but does not necessarily indicate a specific order of an object. “First/second/third” is interchangeable in terms of a specific order or sequence if permitted, so that the embodiments of this application described herein can be implemented in a sequence in addition to the sequence shown or described herein.

In the embodiment of this application, the term “module” or “unit” refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processors or memories) may be configured to implement one or more modules or units. In addition, each module or unit may be a part of an overall module or unit including a function of the module or unit.

During application of the relevant data collection and processing (for example, obtaining a prompt that needs to be processed) in this application, the informed consent or individual consent of a personal information subject needs to be obtained in strict accordance with the requirements of relevant laws and regulations, and the subsequent data use and processing behavior is carried out within the scope of authorization of laws and regulations and the personal information subject.

Unless otherwise defined, meanings of all technical and scientific terms used in the embodiments of this application are the same as those usually understood by a person skilled in the art. Terms used in this embodiment are merely intended to describe objectives of the embodiments of this application, but are not intended to limit this application.

Before the embodiments of this application are further described in detail, nouns and terms included in the embodiments of this application are described, and the following explanations are applicable to the nouns and terms included in the embodiments of this application
1) Single-image generation and sorting: For a specific prompt, an image generation model is called to generate a plurality of generated images for the prompt, then the plurality of generated images are evaluated, to determine an evaluation index of each generated image, and the plurality of generated images are sorted based on the evaluation indexes, to sift a generated image matching the prompt.
2) Sequence generation and sorting: For a plurality of prompts, a generated image is obtained after single-image generation and sorting is performed for a first prompt, and then, generated images of a subsequent non-first prompt are re-sorted based on the generated image of the first prompt to obtain a corresponding generated image until corresponding generated images are obtained for all the prompts, to finally obtain an image sequence for the plurality of prompts.

The embodiments of this application provide an image processing method, an image processing apparatus, an electronic device, a computer-readable storage medium, and a computer program product, to improve an overall image-text correlation by performing generability recognition on a prompt in a text-to-image generation scenario.

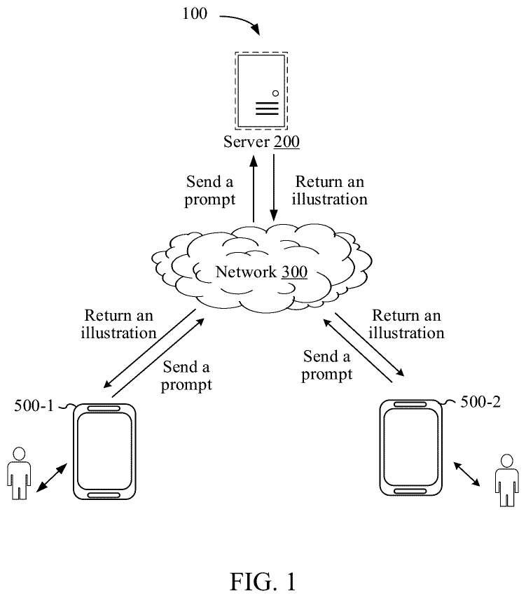

Referring FIG. 1, FIG. 1 is a schematic diagram of an architecture of an image processing system 100 according to an embodiment of this application, including a terminal (for example, a terminal 500-1 and a terminal 500-2 are shown), a network 300, and a server 200. The terminal (for example, the terminal 500-1 and the terminal 500-2 are shown) is connected to the server 200 by the network 300. The network 300 may be a wide area network, a local area network, or a combination of the two.

Applications (APPs) for various document editing application scenarios are run on the terminal (for example, the terminal 500-1 and the terminal 500-2 are shown), and may be, for example, an instant messaging APP, a reading APP, a video APP, a document editor, or another software program having a document editing function. After a user inputs a prompt for which an image needs to be generated into a document edited on the APP, the inputted prompt is received and sent to the server 200 through the network 300. The server 200 receives the prompt sent by the terminal, first obtains a plurality of generated images of the prompt to determine an illustration of the prompt from the plurality of generated images, then extracts a text feature of the prompt, and maps the text feature to a generability index and a description type of the prompt. When the generability index is greater than an index threshold, the description type represents that the prompt does not include a verb, and the prompt includes a plurality of clauses, similar images whose image-text similarities are greater than an image-text similarity threshold and that respectively correspond to the plurality of clauses are obtained, then, an image difference between the similar images is determined, and the similar images whose image difference is less than an image difference threshold are used as illustrations of the clauses. Finally, the illustration of the prompt and the illustrations of the plurality of clauses are returned together to the terminal (for example, the terminal 500-1 and the terminal 500-2 are shown) through the network 300, and inserted into the currently edited document.

In some embodiments, in a document editing APP on a terminal, a user inputs, prompts for which images need to be generated, and the terminal may directly process the inputted prompts, including: first obtaining a plurality of generated images of the prompts to determine illustrations of the prompts from the plurality of generated images, then extracting text features of the prompts, and mapping the text features to generability indexes and description types of the prompts. When the generability index is greater than an index threshold, the description type represents that the prompt does not include a verb, and the prompt includes a plurality of clauses, similar images whose image-text similarities are greater than an image-text similarity threshold and that respectively correspond to the plurality of clauses are obtained, then, an image difference between the similar images is determined, and the similar images whose image difference is less than an image difference threshold are used as illustrations of the clauses. Then, the illustration of the prompt and the illustration of the clause are directly displayed on the document editing interface of the APP.

For example, in some novel or script editing scenarios, document editor software run on a terminal may receive, in real time, a novel sentence that is inputted by a user and for which a corresponding image needs to be generated, then quickly generate a large quantity of generated images based on the novel sentence to obtain an illustration of the novel sentence, subsequently, process the novel sentence, determine similar images of a plurality of clauses in the novel sentence as illustrations of the clauses, and finally return the illustration of the novel sentence and the illustrations of the clauses to an illustration interface of the document editor software.

In some embodiments, the server 200 shown in FIG. 1 may be an independent physical server, or may be a server cluster formed by a plurality of physical servers or a distributed system, and may further be a cloud server providing basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal (for example, the terminal 500-1 and the terminal 500-2) shown in FIG. 1 may be a smart phone, a tablet computer, a laptop computer, a desktop computer, a smart speaker, a smart watch, a smart television, and an in-vehicle terminal, but this is not limited thereto. The terminal and the server may be directly or indirectly connected in a wired or wireless communication manner. This is not limited in the embodiments of this application.

The embodiments of this application may be implemented with the help of the artificial intelligence (AI) technology, which is a theory, method, technology, and application system that uses a digital computer or a machine controlled by the digital computer to simulate, extend, and expand human intelligence, perceive an environment, acquire knowledge, and use knowledge to obtain an optimal result. In other words, AI is a comprehensive technology in computer science. This technology attempts to understand the essence of intelligence and produce a new intelligent machine that can react in a manner similar to human intelligence. AI is to study the design principles and implementation methods of various intelligent machines, so that the machines can perceive, infer, and make decisions.

Using the server provided in this embodiments as an example, a server cluster that may be deployed on a cloud to open an AI as a Service (AIaaS) to users or developers. The AIaaS platform splits several common AI services, and provides independent or packaged services in the cloud. This service mode is similar to opening an AI theme mall, and all users or developers can access, through application programming interfaces, one or more artificial intelligence services provided by the AIaaS platform.

For example, an image processing program provided in embodiments of this application is encapsulated in the server on the cloud. A user calls an image processing service in a cloud service through a terminal (an APP, such as an instant messaging APP or a reading APP, is run on the terminal), to cause a server deployed on a cloud to call an encapsulated image processing program, to first obtain, by receiving a text inputted by the user, a plurality of generated images of the text, to determine an illustration of the inputted text from the plurality of generated images, and then, extract a text feature of the text and map the text feature to a generability index and a description type of the inputted text. When the generability index is greater than an index threshold, the description type represents that the inputted text does not include a verb, and the inputted text includes a plurality of clauses, similar images whose image-text similarities are greater than an image-text similarity threshold and that respectively correspond to the plurality of clauses are obtained, then, an image difference between the similar images is determined, and the similar images whose image difference is less than an image difference threshold are used as illustrations of the clauses, and inserted into an interface of document editing.

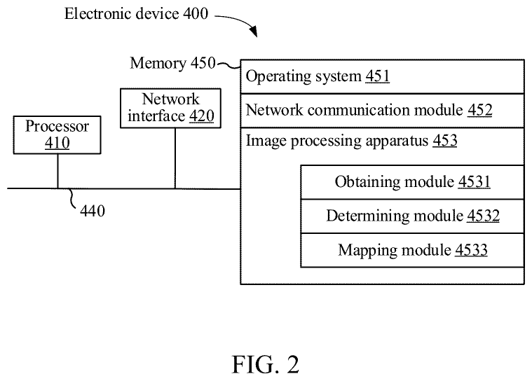

Referring to FIG. 2, FIG. 2 is a schematic structural diagram of an electronic device 400 according to an embodiment of this application. The electronic device 400 may be implemented as the server 200 shown in FIG. 1 or may be implemented as the terminal (for example, the terminal 500-1 and the terminal 500-2 are shown) shown in FIG. 1. The electronic device 400 shown in FIG. 2 includes: at least one processor 410, a memory 450, and at least one network interface 420. All components in the electronic device 400 are coupled together by a bus system 440. The bus system 440 is configured to implement connection and communication between the components. In addition to a data bus, the bus system 440 also includes a power supply bus, a control bus, and a status signal bus. However, for clarity, various buses are marked as the bus system 440 in FIG. 2.

The processor 410 may be an integrated circuit chip having a signal processing capability, for example, a general-purpose processor, a digital signal processor (DSP), or another programmable logic device, discrete gate, transistor logical device, or discrete hardware component. The general purpose processor may be a microprocessor, any conventional processor, or the like.

The memory 450 may be a removable memory, an irremovable memory, or a combination thereof. Hardware devices include a solid-state memory, a hard disk drive, an optical disc driver, or the like. The memory 450 in some embodiments includes one or more storage devices that are physically located away from the processor 410.

The memory 450 includes a volatile memory or a non-volatile memory, or may include a volatile memory and a non-volatile memory. The non-volatile memory may be a read-only memory (ROM). The volatile memory may be a random access memory (RAM). The memory 450 described in the embodiments of this application is intended to include memories of any other suitable types.

In some embodiments, the memory 450 may store data to support various operations. Embodiments of the data include programs, modules, and data structures, or a subset or a superset thereof, which are illustrated below.

An operating system 451 includes system programs configured to process various basic system services and execute hardware-related tasks, for example, a framework layer, a core library layer, and a driver layer, for implementing various basic services and processing hardware-based tasks.

A network communication module 452 is configured to reach another electronic device through one or more (wired or wireless) network interfaces 420. Network interfaces 420 may include: Bluetooth, wireless fidelity (Wi-Fi), a universal serial bus (USB), and the like.

In some embodiments, the apparatus provided in the embodiments of this application may be implemented by software. FIG. 2 shows an image processing apparatus 453 stored in a memory 450, which may be software in a form of a program and a plug-in, and includes an obtaining module 4531, a determining module 4532, and a mapping module 4533. The modules are logical and may be combined in different manners or further split based on to-be-implemented functions. Functions of the modules are described below.

In some embodiments, the terminal or the server may implement the image processing method provided in embodiments of this application by running various computer-executable instructions or a computer program. For example, the computer-executable instructions may be a microprogram-level command, machine instructions, or software instructions. The computer program may be a native program or a software module in an operating system; may be a native application (APP), namely, a program that needs to be installed in an operating system to run; or may be a mini program that may be embedded in any APP, namely, a program that only needs to be downloaded into a browser environment to run. To sum up, the computer-executable instructions may be instructions in any form, and the foregoing computer program may be an application, a module, or a plug-in in any form.

The image processing method provided in the embodiments of this application is described with reference to the applications and implementations of the electronic device provided in the embodiments of this application.

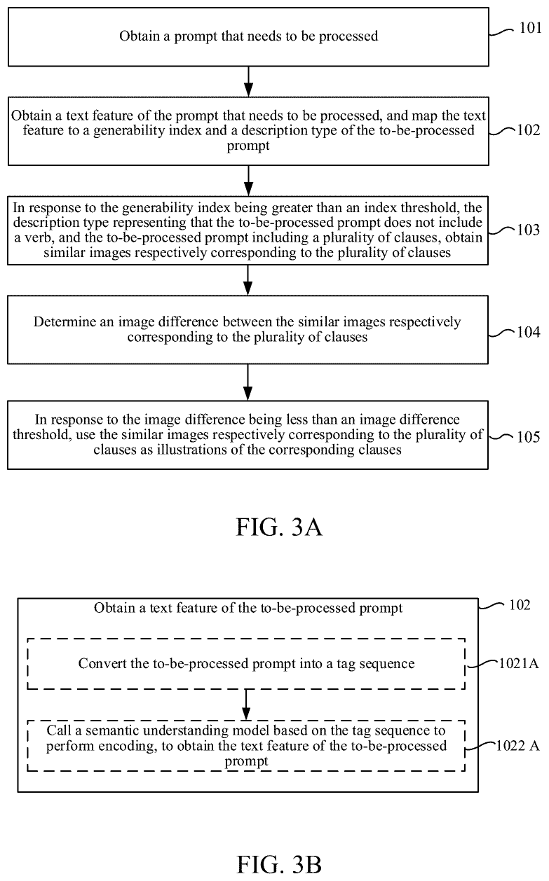

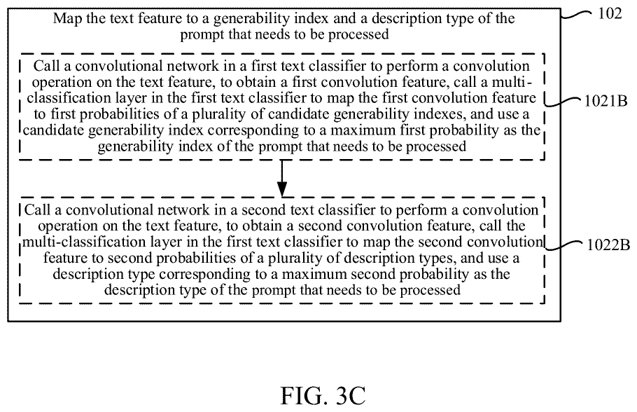

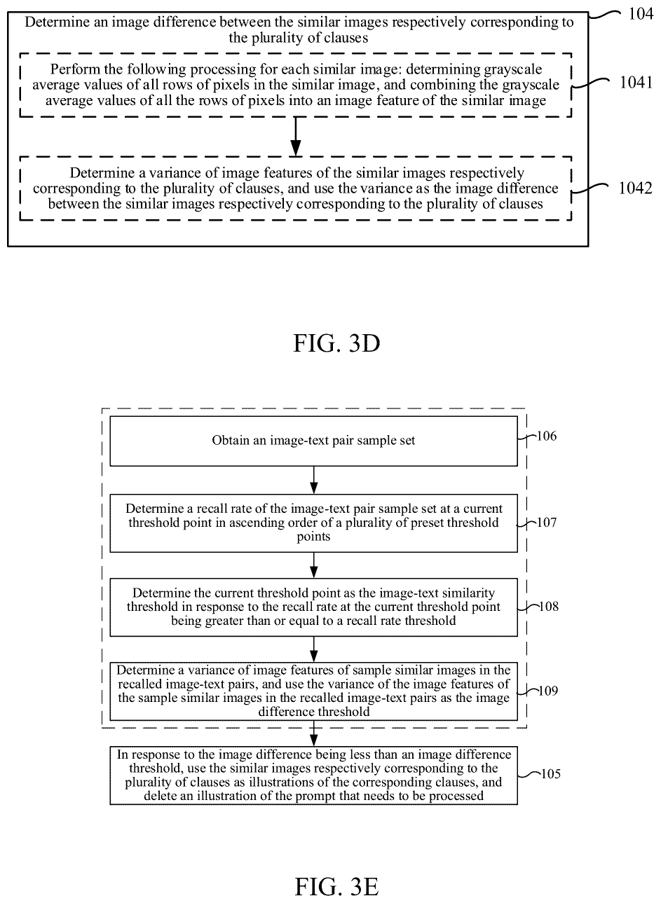

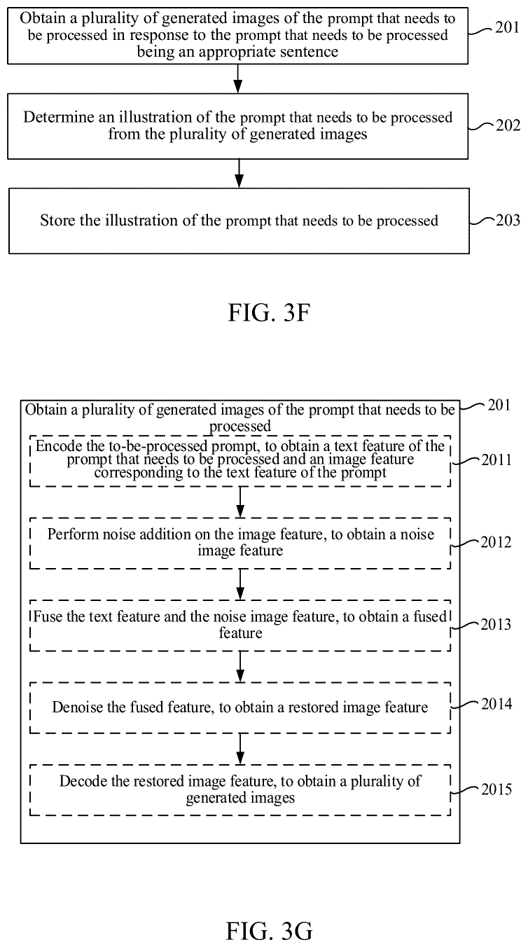

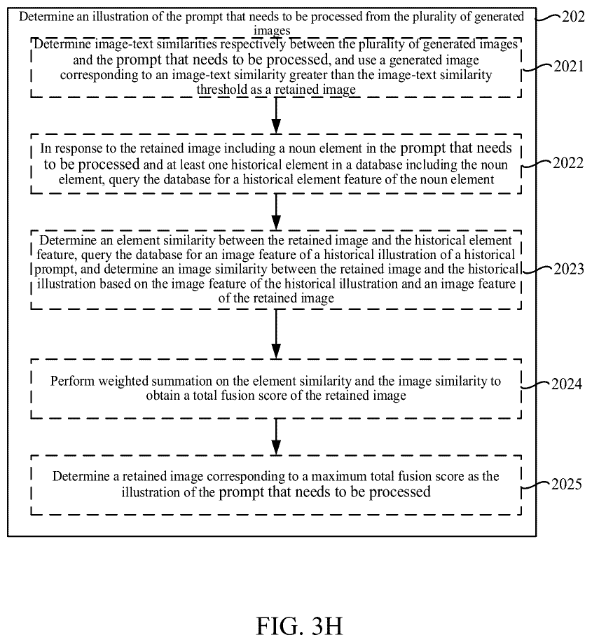

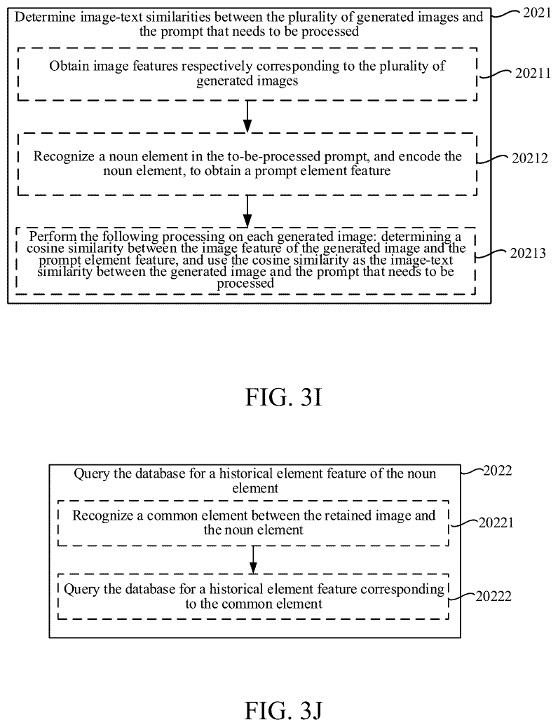

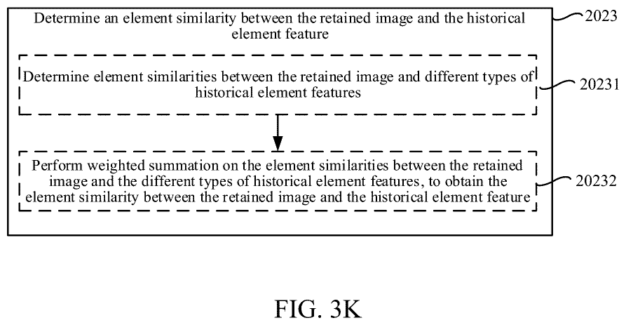

Referring to FIG. 3A, FIG. 3A is a schematic flowchart of an image processing method according to an embodiment of this application. The method may be performed by an electronic device. Descriptions are provided with reference to operations shown in FIG. 3A.

Operation 101: Obtain a prompt that needs to be processed. to

In some embodiments, the prompt that needs to be processed may be a text inputted by a user or a computer program (that is, an artificial intelligence-based text creation program), may be a sentence in a novel or a script article, may be a sentence including a plurality of clauses, or may be a plurality of sentences. The prompts are configured to describe some target subjects. The target subjects may be subjects that are in novels or script articles and that have particular themes or styles, for example, a martial arts subject, a history subject, a food subject, and a travel subject. Then, an image generation model is called to generate a plurality of corresponding generated images for the prompt that needs to be processed. Similar to the prompt that needs to be processed, the generated images are all configured for describing a same target subject, for example, a martial arts subject, a history subject, a food subject, or a travel subject.

Operation 102: Obtain a text feature of the prompt that needs to be processed, and map the text feature to a generability index and a description type of the prompt that needs to be processed.

In a process of selecting an illustration for each prompt that needs to be processed in the inputted text, in consideration of that the prompt that needs to be processed may include a plurality of clauses, and the clauses all describe different content, it is difficult for the illustration to completely embody content described in all the clauses in the prompt that needs to be processed. The prompt that needs to be processed may be further processed in the following manner: performing generability recognition on the prompt that needs to be processed, to split the prompt that needs to be processed into a plurality of clauses, and generate an illustration corresponding to each clause.

In some embodiments, referring to FIG. 3B, “obtain a text feature of the prompt that needs to be processed” in operation 102 shown in FIG. 3A may be implemented through the following operation 1021A and operation 1022A, which is described below in detail.

Operation 1021A: Convert the prompt that needs to be processed into a tag sequence.

In some embodiments, to perform generability recognition on the prompt that needs to be processed, the text feature of the prompt that needs to be processed needs to be processed through a sentence generability recognition model, which is implemented in the following manner: extracting the text feature of the prompt that needs to be processed, and calling a semantic understanding model based on the extracted text feature of the prompt that needs to be processed to perform embedding on the prompt that needs to be processed, to obtain an embedded tag sequence corresponding to the prompt that needs to be processed. The semantic understanding model may be a bidirectional encoder representations from transformers (BERT) model.

Operation 1022A: Call a semantic understanding model based on the tag sequence to perform encoding, to obtain the text feature of the prompt that needs to be processed.

To follow the foregoing embodiment, after the embedded tag sequence of the prompt that needs to be processed is obtained, the semantic understanding model is called to encode the embedded tag sequence of the prompt that needs to be processed, to obtain the text feature of the prompt that needs to be processed.

In some embodiments, referring to FIG. 3C, “map the text feature to a generability index and a description type of the prompt that needs to be processed” in operation 102 shown in FIG. 3A may be implemented through the following operation 1021B and operation 1022B, which is described below in detail.

Operation 1021B: Call a convolutional network in a first text classifier to perform a convolution operation on the text feature, to obtain a first convolution feature, call a multi-classification layer in the first text classifier to map the first convolution feature to first probabilities of a plurality of candidate generability indexes, and use a candidate generability index corresponding to a maximum first probability as the generability index of the prompt that needs to be processed.

After the text feature of the prompt that needs to be processed is obtained, the sentence generability recognition model may be called to perform prediction on the text feature. The sentence generability recognition model is configured to determine whether the corresponding prompt that needs to be processed is appropriate for the image generation model to generate an image, that is, determine whether the prompt that needs to be processed is a sentence inappropriate for image generation. Specifically, two text classifiers are included and respectively configured to predict whether descriptive content of a generated image corresponding to the prompt that needs to be processed conforms to descriptive content of the prompt that needs to be processed, and whether the prompt that needs to be processed is an action description sentence. The convolutional network in the first text classifier is called to perform a convolution operation on the text feature of the prompt that needs to be processed, to obtain a first convolution feature. The convolutional network may be a plurality of convolutional layers, for example, two convolutional layers. Then, the multi-classification layer in the first text classifier is called to map the first convolution feature to first probabilities of a plurality of candidate generability indexes, and use a candidate generability index corresponding to a maximum first probability as the generability index of the prompt that needs to be processed.

In some embodiments, there may be three candidate generability indexes, for example, 0, 1, and 2. That is, the first text classifier performs three-category prediction. When the candidate generability index is 0, it is predicted that descriptive content of none of the plurality of generated images corresponding to the prompt that needs to be processed is the same as descriptive content of the prompt that needs to be processed, and the prompt that needs to be processed is inappropriate for illustration generation. When the candidate generability index is 1, it is predicted that descriptive content of a small group of generated images in the plurality of generated images corresponding to the prompt that needs to be processed is the same as the descriptive content of the prompt that needs to be processed, and the prompt that needs to be processed is also inappropriate for illustration generation. When the candidate generability index is 2, it is predicted that descriptive content of a large group of generated images in the plurality of generated images or even all the generated images corresponding to the prompt that needs to be processed is the same as the descriptive content of the prompt that needs to be processed, and the prompt that needs to be processed is appropriate for illustration generation. Moreover, the generability index is configured to represent a score of an illustration being generable from the prompt that needs to be processed. A scoring standard may be using the candidate generability index directly as a score of the generability index. A higher score (for example, the score is 2) of the generability index indicates a larger reference value of the prompt that needs to be processed for illustration generation.

Operation 1022B: Call a convolutional network in a second text classifier to perform a convolution operation on the text feature, to obtain a second convolution feature, call the multi-classification layer in the first text classifier to map the second convolution feature to second probabilities of a plurality of description types, and use a description type corresponding to a maximum second probability as the description type of the prompt that needs to be processed.

While the generability index of the text feature of the prompt that needs to be processed is determined, the convolutional network in the second text classifier is called to perform a convolution operation on the text feature, to obtain a second convolution feature. The convolutional network may also be a plurality of convolutional layers, for example, two convolutional layers. Then, the multi-classification layer in the first text classifier is called to map the second convolution feature to second probabilities of a plurality of description types, and use a description type corresponding to a maximum second probability as the description type of the prompt that needs to be processed.

In some embodiments, the description type of the prompt that needs to be processed includes: action-included or action-excluded, and is configured for determining whether the prompt that needs to be processed is an action description sentence, that is, the second text classifier is a two-category classifier. When the predicted description type is verb-included, the prompt that needs to be processed is an action description sentence, and it is usually difficult to completely embody the action description sentence in an image, resulting in a high failure rate of image generation. That is, when the prompt that needs to be processed includes a verb, the prompt that needs to be processed is inappropriate for illustration generation. When the predicted description type is verb-excluded, the prompt that needs to be processed is not an action description sentence, and the prompt that needs to be processed may be further split to obtain a plurality of clauses, and then the plurality of clauses are respectively configured for secondary image generation.

According to this embodiment, a sentence generability recognition model is configured to perform recognition on a prompt that needs to be processed, to recognize a prompt that needs to be processed that has poor generability and that includes an action, evaluate properness of the prompt that needs to be processed, and further, perform processing feedback on the prompt that needs to be processed, thereby resolving a problem of improper single-time image generation of the prompt that needs to be processed, and avoiding a problem of a poor overall image generation effect due to poor generability and element missing of the prompt that needs to be processed.

Reference may still be made to FIG. 3A. Operation 103: In response to the generability index being greater than an index threshold, the description type representing that the prompt that needs to be processed does not include a verb, and the prompt that needs to be processed including a plurality of clauses, obtain similar images respectively corresponding to the plurality of clauses.

The generability index being greater than an index threshold, the description type representing that the prompt that needs to be processed does not include a verb, and the prompt that needs to be processed including a plurality of clauses can be used as an inappropriate-sentence condition for performing generability recognition on a prompt in a scenario of generating an image based on a text. When the foregoing condition is met, the prompt that needs to be processed is an inappropriate sentence, that is, is not a sentence appropriate for illustration generation.

After sentence generability recognition is performed on the prompt that needs to be processed, when a predicted generability index is greater than the index threshold (for example, the index threshold is 1), a predicted description type represents that the prompt that needs to be processed does not included a verb, and the prompt that needs to be processed includes a plurality of clauses, the prompt that needs to be processed needs to be split, to obtain the plurality of clauses of the prompt that needs to be processed.

A similar image most similar to each clause is respectively searched from all the generated images of the prompt that needs to be processed. Specifically, for each clause in the prompt that needs to be processed, image-text similarities between the clause and all the generated images of the prompt that needs to be processed are calculated. For example, the image-text similarity may be a cosine similarity. A generated image with a maximum image-text similarity is determined from all the generated images as a candidate similar image of the clause. Therefore, a corresponding candidate similar image can be determined for each clause. When an image-text similarity between a clause and a corresponding candidate similar image is greater than an image-text similarity threshold, the corresponding candidate similar image is used as a similar image of the clause.

In some embodiments, when a generability index is greater than the index threshold (for example, the index threshold is 1), and a predicted description type represents that the prompt that needs to be processed includes a verb, the prompt that needs to be processed is an action description sentence, and it is usually difficult to completely embody the action description sentence in an image, resulting in a high failure rate of image generation. The prompt that needs to be processed is inappropriate for illustration generation, and the prompt that needs to be processed is deleted.

In some embodiments, when a generability index is less than the index threshold (for example, the index threshold is 1), the prompt that needs to be processed is inappropriate for illustration generation. In consideration of that different prompts that need to be processed are sequentially extracted from an inputted text, for example, the inputted text is segmented in unit of sentence and based on a period into a plurality of prompts that need to be processed, illustrations of the prompts that need to be processed may be directly stored into an illustration sequence of a text in an order of generation.

Reference may be made to FIG. 3A. Operation 104: Determine an image difference between the similar images respectively corresponding to the plurality of clauses.

After a corresponding similar image is determined for each clause of the prompt that needs to be processed, an image difference between similar images is then determined. The image difference may be measured by an image variance.

In some embodiments, referring to FIG. 3D, operation 104 shown in FIG. 3A may be implemented through the following operation 1041 and operation 1042, which is described below in detail.

Operation 1041: Perform the following processing for each similar image: determining grayscale average values of all rows of pixels in the similar image, and combining the grayscale average values of all the rows of pixels into an image feature of the similar image.

In some embodiments, for each similar image, grayscale processing is performed on the similar image, to obtain a corresponding grayscale image. For a grayscale image of each similar image, average values of grayscale values of all rows of pixels of the similar image are sequentially calculated respectively, and the average values of the grayscale values of all the rows of pixels are recorded and combined as an image feature of the similar image.

Operation 1042: Determine a variance of image features of the similar images respectively corresponding to the plurality of clauses, and use the variance as the image difference between the similar images respectively corresponding to the plurality of clauses.

To follow the foregoing embodiment, variance calculation is performed on all the obtained average values, and an obtained variance is an eigenvalue of the similar image. After an eigenvalue is calculated for each similar image, the eigenvalues are compared with each other to determine a difference (referred to as a variance difference for short) between variances of any two similar images, a variance with a maximum variance difference is used as a total variance of the plurality of similar images, and the total variance is used as the image difference between the similar images respectively corresponding to the plurality of clauses.

Reference may still be made to FIG. 3A. Operation 105: In response to the image difference being less than an image difference threshold, use the similar images respectively corresponding to the plurality of clauses as illustrations of the corresponding clauses.

When the image difference between the similar images respectively corresponding to the plurality of clauses is less than the image difference threshold, the plurality of clauses of the prompt that needs to be processed have a small difference and correspondingly describe similar content, and splitting is no longer needed for generation. Therefore, the similar images corresponding to the plurality of clauses are directly used as illustrations, and the illustrations are stored in an order of the clauses in the prompt that needs to be processed into an illustration sequence corresponding to the inputted text.

In some embodiments, when the image difference between the similar images respectively corresponding to the plurality of clauses of the prompt that needs to be processed is greater than or equal to the image difference threshold, content described by the plurality of clauses of the prompt that needs to be processed has a great difference, and the plurality of clauses may describe different content. In this case, it is determined that the current prompt that needs to be processed is an inappropriate sentence. That is, the similar images corresponding to the clauses of the prompt that needs to be processed have poor association, and the clauses in the prompt that needs to be processed need to be further split. In this case, operation 101 shown in FIG. 3A is further performed, to cause the image processing method provided in the embodiments of this application to be re-executed on the prompt that needs to be processed corresponding to the plurality of clauses, thereby finally determining an illustration of the prompt that needs to be processed.

The image difference between the similar images respectively corresponding to the plurality of clauses being greater than or equal to an image difference threshold can be used as an inappropriate-sentence condition for performing generability recognition on a prompt in a scenario of generating an image based on a text. When the image difference between the similar images corresponding to the clauses is greater than or equal to the image difference threshold, the prompt is an inappropriate sentence, that is, is not a sentence appropriate for illustration generation.

In some embodiments, referring to FIG. 3E, before operation 105 shown in FIG. 3A is performed, the following operation 106 to operation 109 may be further performed, to obtain an image difference threshold, which is described below in detail.

Operation 106: Obtain an image-text pair sample set.

In some embodiments, before the similar images corresponding to the plurality of clauses are obtained, an image-text similarity threshold needs to be determined, for sifting a generated image most similar to a clause as a similar image of the clause. In addition, to improve a sequence correlation of the similar images of the clauses, subsequently, an image difference between the similar images further needs to be determined. Therefore, an image difference threshold also needs to be set. The method for determining the image-text similarity threshold and the image difference threshold is collecting a large quantity of image-text pairs to form an image-text pair sample set for performing searching and obtaining. An image-text pair includes a sample prompt and a sample similar image.

Operation 107: Determine a recall rate of the image-text pair sample set at a current threshold point in ascending order of a plurality of preset threshold points.

A specific quantity of (for example, 10000) image-text pairs are obtained, and are arranged in ascending order of a plurality of preset threshold points. For example, the threshold points may be set from 0 to 1 with 0.1 as a unit stride. Then, similarity indexes between a sample prompt and a sample similar image of each of the 10000 image-text pairs are calculated respectively at different threshold points. The similarity index may be a cosine similarity. A specific calculation method is described in operation 20213 below. In the image-text pairs, an image-text pair having a similarity index greater than or equal to a threshold point is used as a recalled image-text pair, and a quantity of recalled image-text pairs is counted, to determine a proportion of the quantity of recalled image-text pairs having a similarity index greater than the threshold point to a total quantity of image-text pairs (10000 image-text pairs), and use the proportion as a recall rate at the corresponding threshold point.

Operation 108: Determine the current threshold point as the image-text similarity threshold in response to the recall rate at the current threshold point being greater than or equal to a recall rate threshold.

If the recall rate at the current threshold point is greater than or equal to the recall rate threshold, the current threshold point is determined as the image-text similarity threshold. The recall rate threshold may be determined based on a quantity of image-text pair sets, for example, may be 80%. That is, when the recall rate at the current threshold point is greater than or equal to 80%, the current threshold point is used as the image-text similarity threshold.

Operation 109: Determine a variance of image features of sample similar images in the recalled image-text pairs, and use the variance of the image features of the sample similar images in the recalled image-text pairs as the image difference threshold.

After the recalled image-text pairs are obtained, the variance of the image features of the sample similar images in the recalled image-text pairs is then calculated. The variance of the image features is configured to represent a difference between images. A larger variance indicates a larger image difference, and a smaller variance indicates a smaller image difference, that is, a high image similarity. After the variance is determined, the variance of the image features of the sample similar images in the recalled image-text pairs is used as the image difference threshold.

For example, assuming that there are 10000 image-text pairs, and it is determined that the recall rate is 80%, the searching is stopped. In this case, image-text similarities of the 8000 image-text pairs are greater than the current threshold point, and the current threshold point is used as the image-text similarity threshold, so that 8000 recalled image-text pairs are obtained. A variance of sample similar images corresponding to the 8000 recalled image-text pairs is calculated, and the variance is used as the image difference threshold.

According to this embodiment, based on selecting illustrations from generated images of prompts for the first time, according to descriptions of the prompts and the generated images, prompts with poor illustration quality are automatically recognized by using a sentence generability recognition model with reference to a generated-image distribution status, and processing feedback is provided. Specifically, by performing generability evaluation on the prompts and determining description types of the prompts, it can be recognized whether a prompt is a detailed descriptive action and whether the prompt is appropriate for illustration generation, to automatically split or delete the prompt, and process clauses split from the prompt, thereby implementing properness evaluation on a prompt that needs to be processed at a clause granularity and finer-grained image selection. Therefore, image generation is more proper, and a correlation of an overall generation result of the prompt that needs to be processed is improved.

In some embodiments, referring to FIG. 3F, after operation 101 shown in FIG. 3A is performed, the following operation 201 to operation 203 may be further performed, which is described below in detail.

Operation 201: Obtain a plurality of generated images of the prompt that needs to be processed in response to the prompt that needs to be processed being an appropriate sentence.

The appropriate sentence is a sentence that does not meet an inappropriate-sentence condition. The inappropriate-sentence condition includes at least one of the following: the generability index is greater than an index threshold, the description type represents that the prompt that needs to be processed does not include a verb, and the prompt that needs to be processed includes a plurality of clauses; the image difference is greater than or equal to the image difference threshold; and the generability index is greater than the index threshold, and the description type represents that the prompt that needs to be processed includes a verb.

In some embodiments, referring to FIG. 3G, “obtain a plurality of generated images of the prompt that needs to be processed” in operation 201 shown in FIG. 3F may be implemented through the following operation 2011 to operation 2015, which is described below in detail.

Operation 2011: Encode the prompt that needs to be processed, to obtain a text feature of the prompt that needs to be processed and an image feature corresponding to the text feature of the prompt that needs to be processed.

In some embodiments, after the prompt that needs to be processed is obtained, a text encoder of a contrastive language-image pre-training (CLIP) model may be called to encode the prompt that needs to be processed, to obtain a text feature of the prompt that needs to be processed. The CLIP model is trained based on image-text pair samples. When the CLIP model is configured for prediction, a matching image-text pair is outputted based on a prediction sample corresponding to an input. However, when the input is only a text, an image feature can also be randomly generated when a corresponding text feature is outputted. However, the image feature does not correspond to the text feature. The image feature may have a random pixel feature, or may not have any pixel feature.

Operation 2012: Perform noise addition on the image feature, to obtain a noise image feature.

To follow the foregoing embodiment, the image generation model is called to perform noise addition on the randomly generated image feature, that is, gradually add random noise elements to the image feature, and after a plurality of time steps, the image feature becomes a completely random noise image feature.

Operation 2013: Fuse the text feature and the noise image feature, to obtain a fused feature.

Next, the text feature of the prompt that needs to be processed is fused with the completely random noise image feature, to obtain a fused feature. Because the text feature of the prompt that needs to be processed carries an element of a target subject, the text feature can be recognized by an image generation model, and may be configured, during denoising, for guiding generation of an image feature having the corresponding element of the target subject.

Operation 2014: Denoise the fused feature, to obtain a restored image feature.

After the text feature of the prompt that needs to be processed is fused into the image generation model, the image generation model denoises the fused feature into which the text feature is fused, that is, gradually removes noise elements from the fused feature, and with reference to an element of a specific subject or a specific style type carried in the text feature, generates, through a denoising process having the same time steps as the noise addition, a restored image feature that has the element of the target subject and that corresponds to the text feature.

Operation 2015: Decode the restored image feature, to obtain a plurality of generated images.

After the restored image feature is obtained through the denoising process, the restored image feature is decoded, to obtain the generated image. Because the generated image is obtained by denoising the noise image feature, and degrees of recognition on the text feature of the prompt by the image generation model are different, this process is random, resulting in that the generated image is not unique.

Operation 2011 to operation 2015 may be repeatedly performed, to obtain different generated images. That is, a plurality of different generated images may be obtained based on the prompt that needs to be processed. In one embodiment, a quantity of generated images corresponding to each prompt that needs to be processed may be specified, for example, may be 10. That is, 10 generated images are generated based on one prompt that needs to be processed.

Reference may still be made to FIG. 3F. Operation 202: Determine an illustration of the prompt that needs to be processed from the plurality of generated images.

In some embodiments, the prompt that needs to be processed may be a text inputted by a user or a computer program (that is, an artificial intelligence-based text creation program), may be a sentence in a novel or a script article or may be a sentence including a plurality of clauses. That is, the prompt that needs to be processed includes a plurality of prompts. Finally obtained illustrations corresponding to the prompt that needs to be processed are an image sequence having sequence consistency. Therefore, for the plurality of prompts in the prompt that needs to be processed, generated images corresponding to each prompt need to be determined respectively while ensuring that the generated images have sequence consistency. That is, sequence image selection is performed for the plurality of prompts, to finally obtain an illustration of the prompt that needs to be processed.

Operation 203: Store the illustration of the prompt that needs to be processed.

In this embodiment, when the prompt that needs to be processed does not meet an inappropriate-sentence condition, the prompt that needs to be processed is an appropriate sentence for illustration generation, and a corresponding illustration is generated through operations 202 and 203. Compared with an illustration solution in which illustrations are pre-generated based on a text and then inappropriate images are deleted, this application can save related computing resources. When the prompt that needs to be processed meets an inappropriate-sentence condition, the prompt that needs to be processed is an inappropriate sentence that is inappropriate for illustration generation. Therefore, subsequent operations 202 and 203 are skipped, so that related computing resources can be saved.

As described above, a processing manner in response to a generability index of a prompt that needs to be processed being greater than an index threshold, a description type representing that the prompt that needs to be processed does not include a verb, and the prompt that needs to be processed including plurality of clauses has been described above, a processing manner in response to a generability index of a prompt that needs to be processed being greater than an index threshold, and a description type representing that the prompt that needs to be processed includes a verb has also been described above, and in addition, a processing manner in response to a generability index being less than or equal to an index threshold has also been described above. When the prompt that needs to be processed does not meet any one of the foregoing cases, the prompt that needs to be processed is appropriate for illustration generation, and the prompt that needs to be processed and a corresponding illustration are retained. For each prompt that needs to be processed extracted from the text, whether the prompt that needs to be processed is appropriate for illustration generation is determined through the foregoing solution, and deletion, splitting, or retention is correspondingly performed, to delete a prompt that is inappropriate for illustration generation. By splitting an excessively long prompt, comprehensiveness of elements in a generated image is ensured, thereby improving an overall correlation between the text and an illustration sequence.

In some embodiments, referring to FIG. 3H, operation 202 shown in FIG. 3F may be implemented through the following operation 2021 to operation 2025, which is described below in detail.

Operation 2021: Determine image-text similarities respectively between the plurality of generated images and the prompt that needs to be processed, and use a generated image corresponding to an image-text similarity greater than the image-text similarity threshold as a retained image.

In some embodiments, when a prompt that needs to be processed is a text inputted by a user or a computer program (that is, an artificial intelligence-based text creation program), and the prompt that needs to be processed is a first prompt extracted from the text, that is, the prompt is the first prompt in prompts that need to be processed, first, image-text similarities between a plurality of generated images and the prompt that needs to be processed are determined, and a corresponding generated image with a maximum image-text similarity is used as a generated image and as an illustration of the first prompt, that is, an illustration of the prompt that needs to be processed.

In some embodiments, when a prompt that needs to be processed is a text inputted by a user or a computer program (that is, an artificial intelligence-based text creation program), and the prompt that needs to be processed is a non-first prompt extracted from the text, for example, the prompt is the second prompt in prompts that need to be processed, first, image-text similarities between a plurality of generated images and the prompt that needs to be processed are determined, and then, a corresponding generated image with an image-text similarity greater than an image-text similarity threshold is used as a retained image. The image-text similarity threshold is preset, or may be obtained by searching and querying a large quantity of image-text pairs.

In some embodiments, referring to FIG. 3I, “determine image-text similarities respectively between the plurality of generated images and the prompt that needs to be processed” in operation 2021 shown in FIG. 3H may be implemented through the following operation 20211 to operation 20213, which is described below in detail.

Operation 20211: Obtain image features respectively corresponding to the plurality of generated images.

In some embodiments, when a prompt that needs to be processed is a text inputted by a user or a computer program (that is, an artificial intelligence-based text creation program), and the prompt that needs to be processed is a non-first prompt extracted from the text, image-text similarities between a plurality of generated images and the prompt that needs to be processed need to be determined, that is, similarities between image features of the generated images and a text feature of the prompt that needs to be processed are calculated. First, image features of the plurality of generated images need to be obtained. For the plurality of generated images, an image encoder of an image branch of the CLIP model is called to encode the plurality of images, to obtain image encoding features corresponding to the plurality of generated images.

Operation 20212: Recognize a noun element in the prompt that needs to be processed, and encode the noun element, to obtain a prompt element feature.

To follow the foregoing embodiment, the prompt that needs to be processed may include a plurality of noun elements. The noun elements need to be embodied in a generated image or an even finally obtained image sequence, and main types of the noun elements include three types such as a character, a prop, and an environment. The image-text similarity represents how much semantic information of a noun element in a prompt is presented on a generated image. Therefore, for each prompt that needs to be processed, each noun element in the prompt that needs to be processed needs to be recognized. The recognition method may be implemented by using a pre-trained cross-modal model plus a multi-label classifier. Moreover, for the generated images corresponding to the prompt that needs to be processed, it also needs to recognize whether a noun element corresponding to the prompt that needs to be processed appears in each generated image, perform recording, and store recognition and recording results in a database as a standard for subsequent sequence image selection.

For example, a noun element in one of the prompts is recognized, to recognize whether the noun element is a character, a prop, or an environment. If the noun element is a character, a prop, or an environment, the corresponding noun element and whether the noun element appears in a corresponding generated image are recorded, a record format being [prompt identifier (ID), image identifier (ID), element type-element (ID)-element name-whether the element appears in the image]. For example, if noun elements “person, sword, dog” are recognized from the prompt, a record format is “i^{th} prompt, j^{th} image, prop-element 1-sword-appear, prop-element 2-dog-appear, character-element 1-person-appear”.

After the noun elements are recognized from the prompt that needs to be processed, other parts, such as an adjective, an adverb, and a preposition, in the prompt are directly removed. For the recognized noun elements, a text encoder of a text branch of the CLIP model is called to encode a plurality of noun elements of the prompt that needs to be processed, to obtain prompt element features corresponding to the plurality of noun elements.

Operation 20213: Perform the following processing on each generated image: determining a cosine similarity between the image feature of the generated image and the prompt element feature, and use the cosine similarity as the image-text similarity between the generated image and the prompt that needs to be processed.

To follow the foregoing embodiment, after a plurality of noun elements of the prompt that needs to be processed are obtained, and corresponding image encoding features and prompt element features are extracted from a plurality of generated images, for each generated image of the plurality of generated images, a similarity between an image encoding feature of the generated image and a prompt element feature is calculated. The similarity may be a cosine similarity. A specific calculation formula is as follows:

$$similarity = cos ( θ ) = \frac{A * B}{‖ A ‖ ‖ B ‖} = \frac{{\sum }_{i = 1}^{n} {A}_{i} * {B}_{i}}{\sqrt{{\sum }_{i = 1}^{n} {( {A}_{i} )}^{2} * \sqrt{{\sum }_{i = 1}^{n} {( {B}_{i} )}^{2}}}} \qquad ( 1 )$$

In the foregoing formula (1), similarity represents a cosine similarity, θ represents a cosine angle of the cosine similarity, A represents an image encoding feature of a generated image, B represents a prompt element feature, Aᵢ represents an image feature of an i^{th} generated image, and Bᵢ represents an i^{th} prompt element feature.

A cosine similarity between an image encoding feature of each generated image and a prompt element feature is used as an image-text similarity between the plurality of generated images and the prompt that needs to be processed. Then, all the generated images are sorted based on the image-text similarities, and then, based on a preset image-text similarity threshold, a generated images corresponding to an image-text similarity greater than the image-text similarity threshold is used as a retained image. There may be a plurality of retained images for a non-first prompt, or a specific quantity of, for example, 10, retained images may be specified.

Reference may still be made to FIG. 3H. Operation 2022: In response to the retained image including a noun element in the prompt that needs to be processed and at least one historical element in a database including the noun element, query the database for a historical element feature of the noun element.

When a prompt that needs to be processed is a text inputted by a user or a computer program (that is, an artificial intelligence-based text creation program), and the prompt that needs to be processed is a first prompt extracted from the text, an illustration of the prompt that needs to be processed, that is, a generated image of the first prompt is used as a historical illustration, and after being associated with noun elements in the first prompt, is stored in the database. Therefore, the noun elements of the first prompt are also referred to as historical elements, the first prompt is also used as a historical prompt, and element features of the noun elements in the historical prompt are prompt element features extracted by using the CLIP model and are stored in the database as historical element features in a corresponding record format.

For example, in the database, a format in which the generated image is associated with the noun elements in the first prompt may be: prop-element 1-cat-[prompt ID-image ID-image feature], prop-element 2-dog-[prompt ID-image ID-image feature], character-element 3-person-[prompt ID-image ID-image feature].

A storage format of a historical element feature may be: element 1-cat-[prompt ID-image ID-cat feature], and a storage format of a historical illustration may be “historical image-[prompt ID-image ID-element type-image feature]”.

When a prompt that needs to be processed is a text inputted by a user or a computer program (that is, an artificial intelligence-based text creation program), and the prompt that needs to be processed is a non-first prompt extracted from the text, for each retained image of the non-first prompt, it can be queried, based on recognition and recording results in the database, whether the retained image includes a noun element in the prompt that needs to be processed. When the retained image includes the noun element in the prompt that needs to be processed, a historical element feature of the corresponding noun element is further queried from the database, that is, a prompt element feature of the noun element of the historical prompt is extracted by using the CLIP model.

In some embodiments, referring to FIG. 3J, “query the database for a historical element feature of the noun element” in operation 2022 shown in FIG. 3H may be implemented through the following operation 20221 and operation 20222, which is described below in detail.

Operation 20221: Recognize a common element between the retained image and the noun element.

For each retained image, when the retained image includes a noun element in the prompt that needs to be processed, a historical element feature of the corresponding noun element is further queried in the database. In the query process, a common element between the retained image and the noun element of the prompt that needs to be processed needs to be recognized first, that is, it needs to determine whether the noun element in the retained image is the same as a historical element stored in the database, to verify whether a record exists in the database for the noun element appearing in the retained image.

Operation 20222: Query the database for a historical element feature corresponding to the common element.

When it is determined that the noun element of the retained image includes a common element with the historical element in the database, that is, when it is determined that the noun element of the retained image has been recorded in the database, a historical element feature corresponding to the common element is determined and obtained for subsequent calculation of an element similarity.

For example, the first prompt (the historical prompt) in the prompts that need to be processed includes three noun elements “person, cat, dog”, and is stored in the database in association with a corresponding generated image. Features of the noun elements corresponding to the first prompt are also stored in the database as historical element features. In this case, it can be determined, based on recognition and recording results in the database, that the three noun elements “person, cat, dog” also appear in a retained image of the second prompt, it can be determined that common elements between the retained image and the noun elements (historical elements) of the first prompt in the database are “person, cat, dog”, that is, it is determined that the noun elements “person, cat, dog” appearing in the retained image have been recorded in the database, and then, historical element features of “person, cat, dog” are determined and obtained for subsequent calculation of an element similarity.

Through this embodiment, when image selection is performed for each non-first prompt that needs to be processed extracted from the text, it is determined whether a historical element in the database exists in a retained image corresponding to the prompt that needs to be processed. Therefore, each prompt that needs to be processed is associated with a corresponding historical element in an image selection process, to ensure element association between illustrations of all prompts that need to be processed, thereby improving a correlation between the illustrations.

Reference may still be made to FIG. 3H. Operation 2023: Determine an element similarity between the retained image and the historical element feature, query the database for an image feature of a historical illustration of a historical prompt, and determine an image similarity between the retained image and the historical illustration based on the image feature of the historical illustration and an image feature of the retained image.

In some embodiments, referring to FIG. 3K, “determine an element similarity between the retained image and the historical element feature” in operation 2023 shown in FIG. 3H may be implemented through the following operation 20231 and operation 20232, which is described below in detail.

Operation 20231: Determine element similarities between the retained image and different types of historical element features.

In some embodiments, after it is determined that there are common elements between noun elements of the retained image and historical elements in the database, and historical element features corresponding to the common elements are obtained, in consideration of that the common elements have different types such as a character, a prop, and an environment, a generation effect of the prompt that needs to be processed may be affected. For example, a first prompt includes historical elements such as a character, a prop, and an environment, a next prompt is very likely to still include an environment historical element of the previous prompt, while a corresponding character element and a corresponding prop element may be different from a character historical element and a prop historical element of the previous prompt. Therefore, when an element similarity between the retained image and the historical element feature is calculated, an emphasis of the element type needs to be determined. Therefore, element similarities respectively between the retained image and different types of historical element features need to be calculated. A method for calculating an element similarity may be: first finding, through query, an image feature of a corresponding retained image from recognition and recording results stored in a database, and then calculating a cosine similarity between the image feature of the retained image and the corresponding historical element feature as an element similarity between the retained image and the historical element feature. A method for calculating a cosine similarity is similar to operation 20213 shown in FIG. 3I, and details are not described herein again.

Operation 20232: Perform weighted summation on the element similarities between the retained image and the different types of historical element features, to obtain the element similarity between the retained image and the historical element features.

To follow the foregoing embodiment, to reflect an emphasis on the element similarities between the retained image and different types of historical elements, a corresponding weight may be set for an element similarity of each type of historical element based on an update frequency of a corresponding type of historical element. Then, based on corresponding weights, weighted summation is performed element similarities respectively between the retained image and the different types of historical element features, to obtain an element similarity between the retained image and the historical element features.

For example, when environment, character, and prop types, such as a forest, a person, and a cat, exist in both the retained image and the historical elements in the database, cosine similarities respectively between image features of the retained image and a “forest” feature, a “person” feature, and a “cat” feature are respectively calculated, and are respectively denoted as a, b, and c. In this case, update frequencies of historical elements are further determined, and it is found that an element of the environment type “forest” appears in a plurality of prompts that need to be processed. Therefore, a large weight, for example, 0.5, may be set. However, the “person” and the “cat” elements have high change frequencies, and may only appear in one or two prompts that need to be processed. Therefore, small weights may be set, for example, respectively 0.4 and 0.1. Next, weighted summation is performed on a, b, and c based on weights 0.5, 0.4, and 0.1 respectively set for “forest”, “person”, and “cat”, to obtain an element similarity between the retained image and “forest”, “person”, and “cat”, and the element similarity is recorded as “0.5a+0.4b+0.1c”.

After the element similarity between the retained image and the historical element features is determined, the database is queried for an image feature of a historical illustration of a historical prompt, namely, an image feature of a generated image corresponding to a first prompt in the database, then, an image similarity between the retained image and the historical illustration is calculated based on the image feature of the historical illustration and an image feature of the retained image. Calculating the image similarity may be calculating a cosine similarity between the image features. A method for calculating the cosine similarity is similar to operation 20213 shown in FIG. 3D, and details are not described herein again.

Reference may still be made to FIG. 3H. Operation 2024: Perform weighted summation on the element similarity and the image similarity to obtain a total fusion score of the retained image.

For each retained image, after the image-text similarity between the retained image and the historical illustration and the element similarity between the retained image and the historical element in the database are determined, an average value between the image-text similarity and the element similarity of the retained image is obtained, and the average value is used as a sequence similarity of the current retained image.

Then, for each retained image, the image-text similarity between the corresponding retained image and the prompt that needs to be processed is determined in operation 2021 shown in FIG. 3H. Weighted summation is performed on the image-text similarity and the sequence similarity of the retained image by setting corresponding weights respectively, for example, by setting the weights to a same value (for example, 0.5 and 0.5), to obtain a total fusion score of the retained image. The weights may be correspondingly adjusted based on a quantity of retained images or a quantity of noun elements of the prompt that needs to be processed, and are not limited to weights having a same value.

Operation 2025: Determine a retained image corresponding to a maximum total fusion score as the illustration of the prompt that needs to be processed.

After a total fusion score of each retained image corresponding to the prompt that needs to be processed is determined, the retained images are sorted based on the total fusion score of each retained image, to obtain a final sorting result, and a retained image with a maximum total fusion score in the sorting result is used as the illustration corresponding to the prompt that needs to be processed. Then, the illustration of the prompt that needs to be processed is stored in the database as a new historical illustration, processing is continued on a next prompt that needs to be processed, and a corresponding illustration is selected for the next prompt that needs to be processed until corresponding illustrations are generated for all the prompts that need to be processed included in the inputted text.

In some embodiments, when a prompt that needs to be processed is a text inputted by a user or a computer program (that is, an artificial intelligence-based text creation program), and the prompt that needs to be processed is a non-first prompt extracted from the text, each time a corresponding illustration is selected for a prompt, the illustration is used as a new historical illustration and stored in the database. Respective prompts may include different noun elements. For three types of historical elements, namely, “character, prop, environment”, stored in the database, when a corresponding illustration is selected for a subsequent prompt that needs to be processed, and a historical element the same as that in the database appears again, a historical element feature corresponding to the historical element in the database is updated. However, for a historical illustration in the database, each time a prompt that needs to be processed is processed to generate a corresponding illustration, a historical image feature of the historical illustration in the database is also updated. In consideration of that the historical prompt and the next prompt are successively processed, the database is dynamically updated based on at least one historical prompt extracted from the inputted text and a corresponding generated image and a historical illustration of the historical prompt. In some embodiments, a method for updating a historical element feature in the database is: when a corresponding illustration is selected for a subsequent prompt that needs to be processed, and a historical element the same as that in the database appears in the retained image corresponding to the prompt that needs to be processed again, performing weighted summation on an element feature of a noun element appearing in the retained image and a historical element feature of a historical element having a same name in the database, to replace the historical element feature before the update with an obtained updated historical element feature. In consideration of that noun elements included in a plurality of prompts that need to be processed do not greatly change, because many prompts may describe a limited quantity of noun elements such as an environment, a character, and a prop, a historical element feature in the database is slowly updated. Therefore, preset weights of the historical element feature and the noun element feature of the current retained image are balanced, and may be, for example, 0.6 and 0.4.

For example, when noun elements such as “forest, person, cat” appear in the retained image, and a historical element feature stored in corresponding data also includes “forest, person, cat”, a noun element feature in the current retained image is added to the database at a weight of 0.4, that is, a historical element feature of “forest, person, cat” in the database*0.6+an element feature of noun elements “forest, person, cat” in the retained image*0.4=a new historical element feature of “forest, person, cat” in the database.

In some embodiments, a method for updating a historical illustration feature in the database is: when a corresponding illustration is selected for a subsequent prompt that needs to be processed, after each time a prompt that needs to be processed is processed to generate a corresponding illustration, performing weighted summation on an image feature of a retained image and an image feature of a historical illustration in the database by presetting corresponding weights, to replace an image feature of the historical illustration before the update with an updated historical illustration feature. In consideration of that for each prompt that needs to be processed, a retained image having a highest total fusion score is finally selected as an illustration, a historical illustration in the database is updated very frequently. Therefore, an image feature of the historical illustration in the database is updated quickly. Therefore, a higher weight is assigned to the image feature of the historical illustration in the database, and a lower weight is correspondingly assigned to an image feature of the current retained image, for example, the weights may be 0.8 and 0.2.

For example, after a prompt that needs to be processed is processed, a retained image with a highest total fusion score is used as an illustration corresponding to the prompt that needs to be processed, and then, an image feature of the current retained image is added to the database at a weight of 0.2, that is, “a historical illustration feature in the database*0.8+an image feature of a retained image*0.2=a new historical illustration feature in the database”.

According to this embodiment, generated images of each prompt in the inputted text are sequenced. A dynamically updated database is constructed as a reference, to constrain image selection for a retained image corresponding to a prompt. An illustration is selected for each corresponding prompt, thereby re-sorting generation results based on consistency of related elements, to obtain a final image sequence sorting result. Therefore, it can be ensured that corresponding illustrations generated for all prompts are consistent, thereby improving association between the illustrations corresponding to the prompts.

An application of this embodiment is described below.

This embodiment can be applied to a scenario of generating illustrations for a martial arts novel, to assist a user of the novel in generating corresponding illustrations for an inputted novel text. In a task of generating consecutive illustrations for consecutive sentences of a martial arts novel based on an image generation model, images need to be generated for a plurality of consecutive sentences. A biggest challenge of a task for consecutive illustrations is to maintain consistency between images in a context, that is, a newly generated image needs to be related to content of a previously generated image. Then, there are usually many clauses in a sentence in a martial arts novel, and the clauses do not have the same descriptive content. Consequently, a plurality of generated images with completely different content may be generated based on a same sentence, and outputting of an inappropriate generated image is prone to a poor effect of a finally generated illustration.

Based on this scenario, in this embodiment, illustrations are generated for consecutive sentences in a novel, text-to-image generation is performed based on an image generation model, and content of images and texts is mined, to adaptively generate and adjust an illustration sequence of the novel, thereby forming a closed-loop consecutive-sentence illustration system. In a case of generating a sequence of images for sentences for a first time, based on descriptions of the text and generated images, the system automatically recognizes sentences with poor illustration quality through a text generability recognition model with reference to a generated-image distribution status, and provides processing feedback, and then, automatically performs effective control on generation site addition and deletion through subsequent secondary processing such as deletion, retention, and splitting, to finally form a closed-loop system for generating consecutive illustrations.

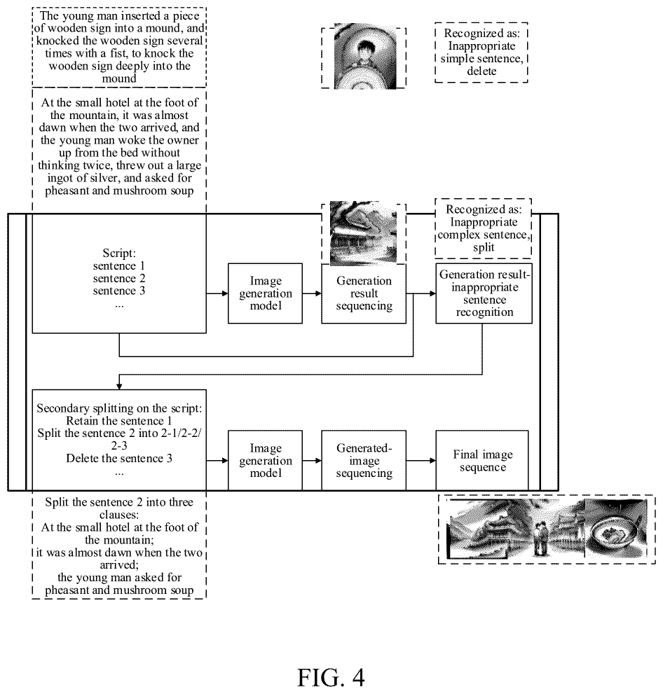

Referring to FIG. 4, FIG. 4 is a schematic diagram of a closed-loop system for generating consecutive illustrations according to an embodiment of this application. The closed-loop system first inputs sentences (for example, sentences 1, 2, and 3 in FIG. 4) in a novel script to an image generation model, generates K (for example, 10) images for each sentence, selects a generated image of each sentence based on a generation result sequencing feedback, performs inappropriate-sentence recognition on the generated images, that is, recognizes, based on the generated images and the generation sentences, a sentence meeting the foregoing inappropriate-sentence conditions as an “inappropriate sentence for image generation”, which is referred to as an inappropriate sentence for short, and performs secondary processing, specifically including deletion, retention, and splitting, on the inappropriate sentence. For example, the sentence 1 is retained. The sentence 2 is split into 2-1, 2-2, and 2-3, and the sentence 3 is deleted. Then, the image generation model is called for a sentence requiring secondary generation to perform image generation, and then, sequence generated images, to obtain a final image sequence.

For example, operations, such as recognizing an inappropriate sentence for image generation, re-generating images after performing secondary splitting on a sentence, sequencing generated images, in the closed-loop system may be cycled a plurality of times. For example, a complex sentence is split into clauses, and a clause is further split into a plurality of subordinate clauses with subject-predicate structures until the split sentences do not include an inappropriate sentence for image generation.

In some examples, as shown in FIG. 4, according to a principle of the closed-loop system, image generation-inappropriate sentence recognition is performed on one sentence (for example, the sentence 3), “The young man inserted a piece of wooden sign into a mound, and knocked the wooden sign several times with a fist, to knock the wooden sign deeply into the mound”, so that the sentence is recognized as an inappropriate simple sentence, and the sentence 3 is deleted. Moreover, image generation-inappropriate sentence recognition is performed on another sentence (for example, the sentence 2), “At the small hotel at the foot of the mountain, it was almost dawn when the two arrived, and the young man woke the owner up from the bed without thinking twice, threw out a large ingot of silver, and asked for pheasant and mushroom soup”, and the sentence is recognized as an inappropriate complex sentence. The sentence needs to be split. That is, the sentence 2 is split into three clauses. Next, the image generation model is called to generate images for the three clauses, and the generated images are sequenced, to obtain a final image sequence.

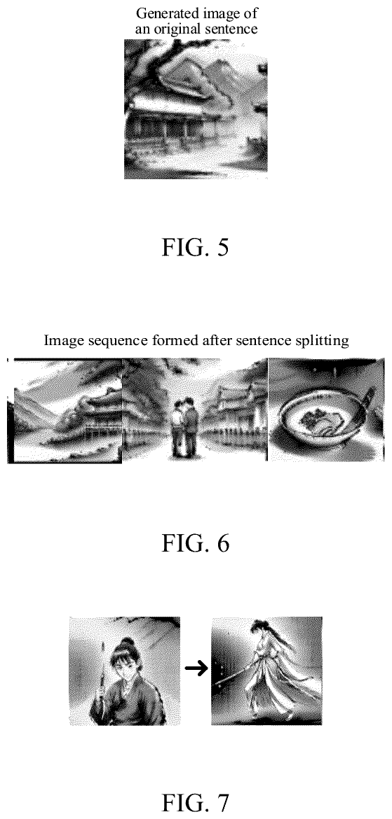

For example, referring to FIG. 5, FIG. 5 is an diagram of image generation based on an original sentence according to an embodiment of this application. For the sentence 2, “At the small hotel at the foot of the mountain, it was almost dawn when the two arrived, and the young man woke the owner up from the bed without thinking twice, threw out a large ingot of silver, and asked for pheasant and mushroom soup”, shown in FIG. 4, the image generation model is directly called to generate an image based on the original sentence. As shown in FIG. 5, it may be seen that only the element “At the small hotel at the foot of the mountain” described in the sentence 2 appears in the image, and descriptive elements in other parts do not appear. In this case, image generation-inappropriate sentence recognition is performed on the original sentence 2 based on the closed-loop system shown in FIG. 4, so that the original sentence 2 is recognized as an “inappropriate complex sentence”. Secondary sentence splitting needs to be performed on the original sentence 2, and specifically, the original sentence 2 is split into the following three clauses: “At the small hotel at the foot of the mountain”, “it was almost dawn when the two arrived”, and “the young man asked for pheasant and mushroom soup”.

Then, secondary generation is performed on the three clauses separately through the image generation model, and generation result sequencing is performed on all generated images generated through the secondary generation on the three clauses, to obtain corresponding three generated images.

Referring to FIG. 6, FIG. 6 is a sequence diagram of secondary image generation after sentence splitting according to an embodiment of this application. As shown in FIG. 6, all descriptive elements in the three clauses of the original sentence 2 respectively correspondingly appear in the three images, and then, the three images are sequenced, that is, the three generated images are fused to obtain an image sequence formed after the sentence is split, and the image sequence is used as a final image sequence of the original sentence 2.

In addition, the closed-loop system can further improve a previous-next frame relationship between generated images, that is, sequence association between generated images. Referring to FIG. 7, FIG. 7 is a schematic diagram of an original generated image sequence according to an embodiment of this application. First, for a first descriptive sentence, “The Kodachi flashed with cold moonlight, and the sweaty girl screamed in fear”, by performing single-image generation and sorting, that is, generating a plurality of generated images based on the descriptive sentence, and sorting the plurality of generated images based on an evaluation index, an image, for example, the first image on the left side of FIG. 7, is selected. Next, for a second descriptive sentence, “The girl in the navy blue swordsman uniform turned around and looked at the broken maple leaves on the ground with her face full of loneliness”, after a plurality of generated images are generated by using the same method, an image, for example, the second image on the right side of FIG. 7, is selected. It can be seen that clothes of the characters appearing in the two images are inconsistent, indicating a previous-next frame relationship between the two generated images is poor, and there is no association.

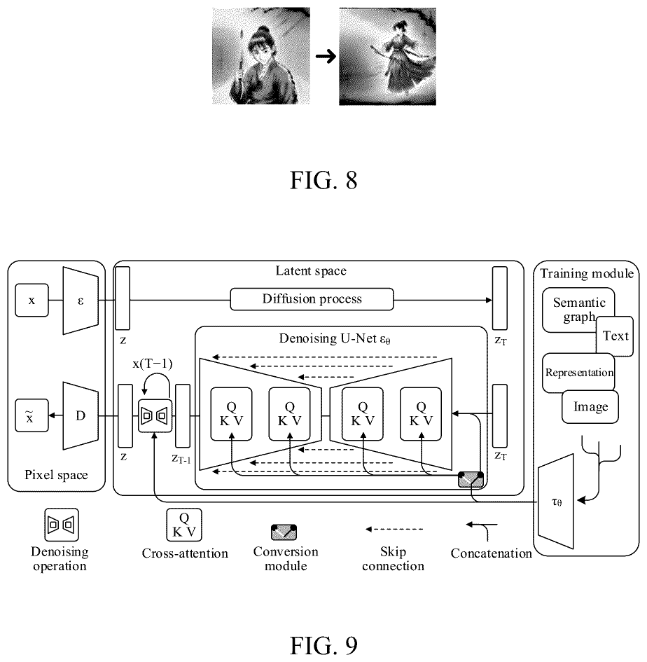

Referring to FIG. 8, FIG. 8 is a schematic diagram of sequence-associated generated images according to an embodiment of this application. According to the method provided in this embodiment, for a first descriptive sentence, “The Kodachi flashed with cold moonlight, and the sweaty girl screamed in fear”, single-image generation and sorting is performed to select a generated image, for example, the first image on the left side of FIG. 8. For a second descriptive sentence, “The girl in the navy blue swordsman uniform turned around and looked at the broken maple leaves on the ground with her face full of loneliness”, after the generated images are obtained by performing single-image generation and sorting, (image) sequence generation and sorting is then performed, and a sequence-image that is more similar to the second descriptive sentence and that is associated with a character or an element in the generated images of the first descriptive sentence, specifically, for example, the second image on the right side of FIG. 8, is selected. Upon comparison on the image sequence formed by the two images in FIG. 7 with the image sequence formed by the two images in FIG. 8, the latter has a stronger previous-next frame relationship, namely, higher sequence association between the generated images, than the former.

A specific process of the closed-loop system for generating consecutive illustrations is described below still with reference to FIG. 4.

As shown in FIG. 4, for a plurality of descriptive sentences (such as a sentence 1, a sentence 2, and a sentence 3) in a novel, the image generation model needs to be called to process the descriptive sentences to generate a plurality of images. In consideration of that the image generation model is trained by using specific image-text pairs, generation effects of different sentences in different text environments are greatly different. For example, for a stable-diffusion model, training images of the model include artworks and photographs shared on websites, and the like.

In some embodiments, to meet the need of generating images based on a novel under a specified subject type, a stable-diffusion model used as an image generation model needs to be fine-tuned, to train the image generation model to generate a generated image of a corresponding subject type based on text content of an inputted subject type. Training samples for the image generation model can be collected from movies and television dramas. Specifically, movies and television dramas of certain subject types are given, for example, a martial arts subject and a history subject. Frames are randomly extracted from the movies and television dramas of these subjects to obtain related images. A total of 100 images may be extracted from the movies and television dramas as training images for the image generation model. In addition, prompt texts for guiding fine-tuning of the image generation model also need to be collected. The prompt texts also come from movies and television dramas of corresponding subject types such as a martial arts subject or a history subject.

Referring to FIG. 9, FIG. 9 is an diagram of an architecture of an image generation model according to an embodiment of this application. For a prompt text, a cross-modal representation model trained based on image-text pairs is configured to perform feature extraction on the prompt text. The cross-modal representation model may be a CLIP model. An input of the CLIP model is a sample pair formed by an image and a text, and a specific architecture includes a text branch and an image branch. The text branch is a text encoder, and specifically, may be a transformer structure, configured to encode an inputted text to obtain a corresponding text feature.

As shown in FIG. 9, a main structure of the image generation model includes three parts. The first part is a pixel space. The pixel space includes a variational autoencoder (VAE) located in the pixel space. The second part is a latent space. The latent space includes a diffusion model (diffusers) located in the latent space and a denoising U-Net model located in the latent space. The third part is a training module. For training samples, semantic graphs, texts, representations, and images are outputted.

An initial input of the image generation model is a training image. Each training image x is inputted into an encoding network c of a VAE, which also referred to as embedding, to obtain a corresponding encoding feature Z. Then, the encoding feature Z is mapped to the latent space, and noise addition is performed by using the diffusion model, which is a diffusion process shown in FIG. 9. A latent-space feature Z_{T} with noise is finally obtained after diffusion and noise addition in T time steps. A specific process of diffusion and noise addition in the latent space is as follows: for the encoding feature Z, performing a forward diffusion operation of the diffusion model, and as a time step T increases, continuously adding random noise to the encoding feature Z, to finally obtain the latent-space feature Z_{T} with completely random noise.

Next, the latent-space feature Z_{T} is inputted into the U-Net model (that is, ε_{θ} shown in FIG. 9) for denoising, and it is expected that a feature of the image is restored through the denoising process. For texts corresponding to the collected images of the movies and television dramas, the text encoder (for example, τ_{θ} shown in FIG. 9) of the text branch of the CLIP model is utilized to perform encoding, so that corresponding text features may be obtained. The text features are inputted to the U-Net model through a conversion module. The conversion module is a controller.

In some embodiments, there are two methods for using a text feature as an input of the U-Net model. Selection of a method may be implemented through the conversion module. The first method is performing concatenation (for example, concatenation shown in FIG. 9) on the text feature and the latent-space feature Z_{T}, and a fused feature after the concatenation is obtained, and then is used as an initial input of the U-Net model. The second method is first using the latent-space feature Z_{T} as an initial input of the U-Net model, and then concatenating the text feature with an element input in each sampling layer of the U-Net model respectively as a final input of the corresponding sampling layer.

In this embodiment, the denoising process of the U-Net model is described by using the second method, to be specific, the latent-space feature Z_{T} is first used as an initial input of the U-Net model, and the text feature is then concatenated with an element input in each sampling layer of the U-Net model respectively as a final input of the corresponding sampling layer, so that the text feature is fused into the image feature. The U-Net model is divided into a downsampling part and an upsampling part. The two parts each include a plurality of sampling layers, and the sampling layers of the two parts correspond to each other. Each sampling layer is a cross-attention module (QKV module). An input and an output between the cross-attention modules are connected by a skip connection module. In a denoising process, by using an attention constraint of the text feature, an effect that a finally generated image includes the text feature is achieved, so that a subject type of the generated image is the same as the subject type of the prompt text.

For example, as shown in FIG. 9, the U-Net model includes a total of four QKV modules from right to left, two QKV modules on the right side are the downsampling part, and two QKV modules on the left side are the upsampling part. Therefore, from right to left, the first QKV module corresponds to the fourth QKV module, and the second QKV module corresponds to the third QKV module. During training of the U-Net model, an output of the first QKV module is not only inputted to the second QKV module, but also associated with an output of the fourth QKV module by a skip connection. A specific operation is to concatenate the output of the first QKV module with the output of the fourth QKV module head to tail as a final output of the fourth QKV module. In addition, an output of the second QKV module is not only an input of the third QKV module, but also concatenated with an output of the third QKV module by a skip connection as a final output of the third QKV module. Accordingly, a denoising process of one time step of the U-Net model is completed.

As shown in FIG. 9, a fused feature of concatenating the text feature with the latent-space feature Z_{T} is outputted by the fourth QKV module of the U-Net model to obtain a latent-space feature Z_{T-1}, that is, the foregoing process has passed through one time step, and then the foregoing denoising process is repeated T−1 times, that is, x(T−1) shown in FIG. 9, x representing a quantity of times of performing denoising. Accordingly, after a total of T denoising processes of the U-Net model are performed, a restored encoding feature Z is finally obtained. Then, the restored encoding feature Z is inputted to the decoding network D of the VAE for decoding, to obtain a restored image \tilde{x}.

An objective of fine-tuning of the image generation model is to train a style related to illustrations of martial arts novels. When fine-tuning of the image generation model, only parameters of the U-Net model located in the latent space and configured for denoising in the third part need to be trained. Other parameters of the VAE and the CLIP model that encodes an image and a text are all trained, and do not need to be updated in the training process of the image generation model. In the training process of the image generation model, all training images for fine-tuning are inputted to the image generation model as full samples for training, and a total of 1000 iterations (steps) are performed. One training cycle is referred to as one iteration.

In each iteration, because video memory resources of a training machine are limited, all full samples cannot be inputted at once to the image generation model for training. Therefore, all the samples are used in batches for training, and bs samples are inputted as one batch to the image generation model for training.

In some embodiments, a loss function in the fine-tuning process of the image generation model uses a mean square error (MSE) loss, that is, calculates an MSE loss between the restored image and an original training image to which a noise distribution is added. The MSE loss is specifically represented as a mean square error between the fine-tuned training image to which noise is inputted and the restored image from which a noise prediction image is outputted. The formula is as follows:

$$MSE = {\sum }_{i = 1}^{n} {( {y}_{i} - {y}_{i}^{p} )}^{2} \qquad ( 2 )$$

In the foregoing formula (2), yᵢ represents a pixel value of an i^{th} pixel of an image, yᵢ^{p} represents a predicted pixel value of the i^{th} pixel of the image, and n is a quantity of full samples.

A loss value of each iteration is backhauled to the U-Net model in the image generation model by using a stochastic gradient descent algorithm, to update parameters of the to-be-trained U-Net model.

In some embodiments, when the image generation model is trained, a process of the diffusion model (diffusers) in the second part may be a DreamBooth fine-tuning process, DreamBooth being a framework for text-to-image generation training of the diffusion model. During training, two items, “instance_dir” and “instance_prompt”, need to be specified on the framework, “instance_dir” being an instance data path, that is, a directory in which fine-tuning training images are located, and instance_prompt being set to a subject or a style type that needs to be trained, for example, a martial arts novel style or a history style, and therefore, it is acceptable to set the instance_prompt item to “wuxia style”.

After all Nibs batches of training are completed, one iteration ends. A learning rate of 0.0005 is initially used in the training process, and after every 10 iterations, the learning rate becomes 0.1 times the original learning rate. Whether to continue training is determined based on whether the loss function decreases. The training is ended when a loss value no longer decreases or when a specified quantity of iterations is reached. For example, the quantity of iterations reaches 1000. Therefore, description of the fine-tuning process of the image generation model is completed.

After the fine-tuning of the image generation model is completed, the image generation model can be configured for prediction, to directly generate, based on an inputted text having a particular subject style and a random noise image or an encoding feature of the random noise image, a generated image having a subject style the same as that of the text.

Still referring to FIG. 4, after the sentence 1, the sentence 2, and the sentence 3 in the novel script are inputted into the closed-loop system, the foregoing fine-tuned image generation model is called to generate corresponding generated images. A quantity of the generated images may be specified in an image generation process. For example, 10 generated images are constantly generated per sentence. Then, generation result sequencing is performed on 10 generated images generated for each sentence, and a generated image is selected for each sentence.

In some embodiments, performing the generation result sequencing on the generated images may be first performing correlation evaluation on generated images of each sentence, that is, evaluating an image-text similarity, and then performing sequence correlation evaluation on the generated images. The performing correlation evaluation on the generated images is determining similarity indexes between the sentence and the generated images, the similarity index being configured to represent a degree to which semantic information of the sentence is presented on the image.

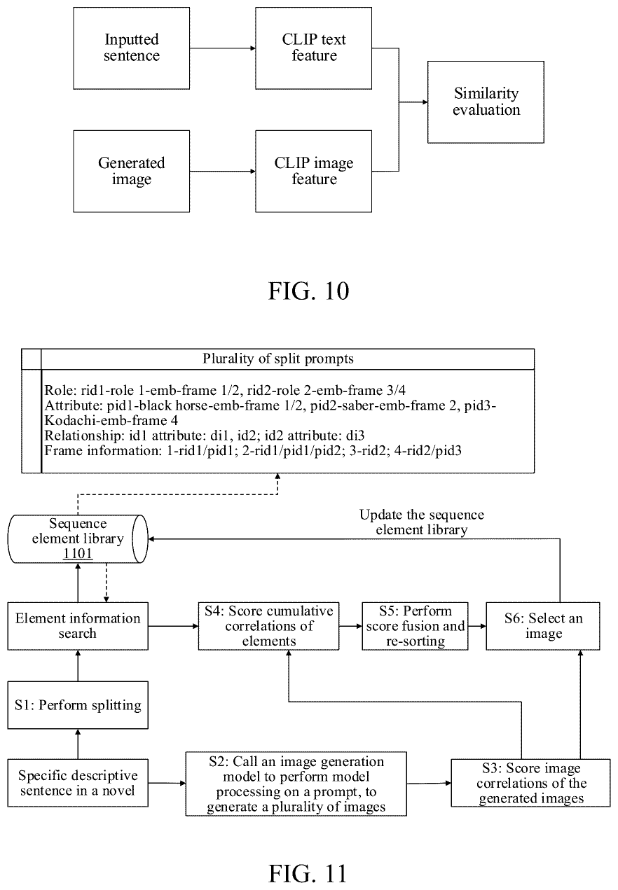

Referring to FIG. 10, FIG. 10 is a diagram of a process of evaluating a correlation of a generated image according to an embodiment of this application. First, the CLIP model is called based on an inputted sentence and corresponding generated images, to encode the inputted sentence, to obtain a CLIP text feature of the inputted sentence and CLIP image features of the generated images. Then, similarities between the CLIP text feature of the inputted sentence and the CLIP image features of the generated images are calculated, to perform similarity evaluation on the inputted sentence and the generated images.

Specifically, a process of performing similarity evaluation on an inputted sentence and a plurality of generated images is as follows:
(1) For a prompt that needs to be processed (that is, the inputted sentence), a key element in the prompt is extracted. Specifically, a noun element (for example, an entity noun) in the prompt is retained, and an adjective and an adverb in the prompt are removed.
(2) An image feature of each generated image is extracted by using the CLIP model.
(3) A text feature of each noun element in the prompt is extracted by using the CLIP model. For example, the prompt is “A person with a mild cat and a dog”, the adjective “mild” in the prompt is removed, three key elements, “cat, dog, person”, are extracted from the prompt. Therefore, a total of three noun elements (features) are retained, and are referred to as prompt element features herein.
(4) For a specific prompt element feature, cosine similarities between image features of all the generated images and the prompt element feature are respectively calculated, and the cosine similarities are returned as similarity indexes, a formula for calculating a cosine similarity being as follows:

$$similarity = cos ( θ ) = \frac{A * B}{‖ A ‖ ‖ B ‖} = \frac{{\sum }_{i = 1}^{n} {A}_{i} * {B}_{i}}{\sqrt{{\sum }_{i = 1}^{n} {( {A}_{i} )}^{2} * \sqrt{{\sum }_{i = 1}^{n} {( {B}_{i} )}^{2}}}} \qquad ( 3 )$$

In the foregoing formula (3), similarity represents a cosine similarity, θ represents a cosine angle of the cosine similarity, A represents an image feature of a generated image, and B represents a prompt element feature, Aᵢ represents an image feature of an i^{th} generated image, and Bᵢ represents an i^{th} prompt element feature.

After similarity indexes between the prompt element features of the inputted sentence and all the generated images are determined, all the generated images may be sorted based on the similarity indexes, and a generated image with a highest similarity index is used as an image of the inputted sentence.

For a plurality of inputted sentences, consistency of generated images of the plurality of inputted sentences needs to be ensured. Therefore, sequence correlation evaluation needs to be performed on the generated images of the plurality of inputted sentences. For a specific process of sequence correlation evaluation, reference may be made to FIG. 11. FIG. 11 is a schematic diagram of performing sequence correlation evaluation on generated images according to an embodiment of this application. A specific process of sequence correlation evaluation is described below with reference to FIG. 11.

For a specific descriptive sentence in a novel, the descriptive sentence including a plurality of prompts, operation S1 is performed, to perform splitting.

For example, each prompt may be split for recognizing a noun element included in the prompt, to recognize whether the noun element is of an element type such as a character, a prop, or an environment. If the noun element is of the element type, the noun element is recorded and stored in a sequence element library 1101. In the sequence element library 1101, a record format of a plurality of split prompts may be “[prompt ID, image ID, element type-element ID-element name-whether the element appears in the image]”, for example, “i^{th} prompt, j^{th} image, prop-element 1-cat-appear, prop-element 2-dog-appear, character-element 1-person-appear”.

An objective of recording whether each noun element appears in a prompt is to provide a standard for determining a sequence of subsequent prompts. Recognition of a character, a prop, and an environment may be performed by using an existing cross-modal multi-label model (or a pre-trained cross-modal model (such as a CLIP model) plus a multi-label classifier) of a service. The cross-modal model includes two input branches, which are respectively an image branch and a text branch. Not only an image-text combined feature can be inputted to the model, but also only an image feature or a text feature is inputted. A label, such as a knife, a sword, or a horse, is outputted.

Referring to FIG. 11, for a first prompt of a specific descriptive sentence in a novel, operation S2 is first performed to call an image generation model to perform model processing on a prompt, to generate a plurality of images.

After operation S2, operation S3 is performed to score image correlations of the generated images.

Image-text similarity evaluation is performed on the generated images of the prompt, and similarity indexes between the prompt and all the generated images are determined, that is, image correlations of the generated images are scored.

In some embodiments, after operation S3, operation S6 is performed to select an image.

Based on the similarity indexes, an image with a highest similarity index is selected from the generated images as a generated image of the first prompt, and its sequence number is denoted as j. Then, the generated image is associated with a noun element of the first prompt and is also stored in the sequence element library. In addition, the noun element of the first prompt is used as a historical element, and a feature of the historical element is recorded and is also stored in the sequence element library. An association format in the sequence element library may be: prop-element 1-cat-[prompt ID-image ID-image feature], prop-element 2-dog-[prompt ID-image ID-image feature], character-element 3-person-[prompt ID-image ID-image feature]. In addition, a feature storing format of the historical element may be: element 1-historical element-[prompt ID-image ID-historical element feature].

After the generated image of the first prompt is obtained, the generated image of the first prompt is stored in the sequence element library 1101 as a historical image. A record format of the historical image is “historical image-element-[prompt-image ID-element type-image feature]”.

In some embodiments, a specific descriptive sentence in a novel includes a plurality of prompts. When a specific descriptive sentence in a novel includes a second prompt, for the second prompt, operation S2 is also performed to call an image generation model to perform model processing on the prompt, to generate a plurality of images. In addition, operation S3 is performed to score image correlations of the generated images.

Then, operation S4 is performed on the generated images of the second prompt, to score cumulative correlations of elements. In addition, operation S5 is performed to perform score fusion and re-sorting.

Operation S4 and operation S5 may be implemented in the following manner: Sorting is performed based on similarity indexes after similarity evaluation is performed. Then, a similarity index threshold may be preset for sifting. If there is no generated image with a similarity index greater than the index threshold, the prompt does not match an image. A generated image with a similarity index greater than the index threshold is determined as a retained image. Next, element information search is performed for each retained image, that is, an appearance situation of a noun element in each retained image is determined based on a result of recognizing the noun element of the prompt in the sequence element library.

Referring to FIG. 11, after element information search is performed for the retained image of the second prompt, if it is determined that a noun element appears in the second prompt, when the noun element in the second prompt appears in the corresponding retained image, whether the noun element exists in historical elements (the noun elements of the first prompt) stored in the sequence element library is queried. If the noun element exists, cumulative correlations of elements are scored based on the retained image. When it is found through query that none of the noun elements exists in the sequence element library, the scoring is skipped.

In some embodiments, a process of scoring cumulative correlations of elements based on the retained image is as follows: When the sequence element library includes the noun elements, features of the historical elements in the sequence element library are first obtained, then corresponding weights are set based on types of the historical elements, image-text similarities between the historical element features of all element types (environment, character, prop) and the current image (the retained image) are respectively calculated, and then, weighted summation is performed on the similarities of all the element types based on the weights to obtain an element similarity of the retained image.

For example, corresponding weights are set to 0.5, 0.4, and 0.1 based on types (environment, character, prop) of the historical elements. When there is no historical element of a corresponding type, a weight of the corresponding type is set to 1. In this case, similarities between the retained image and historical element features of all types (environment, character, prop) are respectively a, b, and c, and finally, an element similarity of the retained image is “0.5a+0.4b+0.1c”.

After the element similarity of the retained image is determined, a feature of a corresponding generated image is found based on an association between the historical elements in the sequence element library and the generated image (the historical image), and then, a similarity between the current retained image and the historical image is calculated and used as a historical-image similarity. That is, a similarity between an image feature of an image (the historical image) generated based on a previous prompt and a current image (the retained image of the second prompt) is calculated.

Referring to FIG. 11, after the cumulative correlations of the elements are scored based on the retained images in operation S4, operation S5 is performed to perform score fusion and re-sorting on each retained image. First, all similarities (an element similarity and a historical-image similarity) of the retained image are averaged to obtain a sequence similarity of the current retained image, thereby determining a sequence similarity of each retained image of the prompt.

For each retained image, a corresponding sequence similarity weight and a corresponding element similarity weight (for example, 0.5 and 0.5) are respectively set for performing weighted summation on the image-text similarity and the sequence similarity of the retained image, to obtain a total fusion score of the retained image. In addition, total fusion scores of all the retained images of the second prompt are calculated, and the retained images are re-sorted based on the total fusion scores, to obtain a final sorting result and return the final sorting result. Then, an image is selected from the sorting result of the retained images, that is, a retained image with a maximum total fusion score in the sorting result is used as an illustration corresponding to the first prompt (corresponding to operation S6 of image selection). Then, an illustration of the second prompt is stored in the sequence element library 1101 as a new historical image.

Still referring to FIG. 11, after each time an image is selected for a prompt in a descriptive sentence in a novel, the sequence element library needs to be updated, to process a next prompt in the descriptive sentence in the novel. The sequence element library is updated because each time an image is selected for a prompt, a corresponding new noun element or new illustration may be generated, and the new noun element and the new illustration are respectively stored in the sequence element library as a historical element feature and a historical image. Therefore, the sequence element library is dynamically updated.

Specifically, an idea of updating the sequence element library is as follows: For each (noun) element in a prop, a character, and an environment in the sequence element library, if a same noun element appears again subsequently, a feature of the noun element in the library is updated by using a momentum update policy. For a historical image in the sequence element library, each time a prompt is processed, a new image is generated as an illustration, and information about the new image is updated to historical image features in the sequence element library by using a momentum update method.

A specific update formula for a momentum update of the sequence element library may be: “new_feat=old_feat*w1+new_image_feat*(1−w1)”, that is, “a new feature of a historical element in the sequence element library=a historical element feature in the sequence element library*a weight+a current new image feature*(1−the weight)”.

By presetting corresponding weights a noun element feature or an image feature of the current image may be fused into the sequence element library at the corresponding weights. In consideration of that the historical image is updated very frequently, and the historical element is updated more slowly, balanced weights, for example, 0.6 and 0.4, may be set for the historical element in the sequence element library, so that a historical element feature in the sequence element library*0.6+a noun element feature having a same name as the historical element feature in the image*0.4=a new feature of the historical element in the sequence element library.

For example, a historical element feature (person) in the sequence element library*0.6+an element feature (person) in the current retained image (the image)*0.4=a new element feature (person) in the sequence element library.

For the historical image in the sequence element library, in consideration of that for each prompt, a retained image (image) having a highest total fusion score is finally selected as an illustration, the historical image in the sequence element library is updated very frequently. Therefore, an image feature of the historical image in the sequence element library is updated quickly. Therefore, a higher weight is assigned to the image feature of the historical image in the sequence element library, and a lower weight is correspondingly assigned to an image feature of the current retained image, for example, the weights may be 0.8 and 0.2.

For example, after a prompt is processed, a retained image with a highest total fusion score is used as an illustration corresponding to the prompt, and an image feature of the current retained image is added to the database at a weight of 0.2, that is, “a historical image feature in the sequence element library*0.8+an image feature of a retained image*0.2=a new historical image feature in the sequence element library”.

In some embodiments, after a corresponding illustration is selected for the second prompt in the descriptive sentence in the novel, and the sequence element library is updated, operation S2 to operation S6 are further performed for a third prompt in the descriptive sentence in the novel, to perform sequence image selection until corresponding illustrations are generated for all prompts in the descriptive sentence in the novel, to obtain a described sequence image selection result.

Through this embodiment, generated images of each prompt in a text inputted by a user are sequenced, a historically generated sequence element library is constructed, sequence correlation evaluation is performed on the generated images of the prompt, and then re-sorting and image selection are performed, thereby avoiding inconsistency between consecutive results. The sequence element library constructed through zero-sample denoising is used as a reference, and the generation results are re-sorted based on consistency of related elements to obtain a final sorting result. Such a fine-grained image selection method is more targeted, and facilitates presentation of elements in a descriptive sentence in a novel. Different from common image selection using coarse-grained image features based on an embedding similarity, in this embodiment, a fine-grained image selection algorithm at an element granularity is designed, to implement more detailed evaluation of noun elements in the prompt and the generated images.

Still referring to FIG. 4, after generation result sequencing is performed on the corresponding generated images of the sentence 1, the sentence 2, and the sentence 3, an image corresponding to each sentence can be obtained. Due to an environment difference between an image and a text, not all texts can be normally used for image generation, for example, a descriptive element “clapper” in a sentence “The night watchman knocked on the clapper and walked by” and a descriptive element “played” in a sentence “He played with two red beans in his hand”.

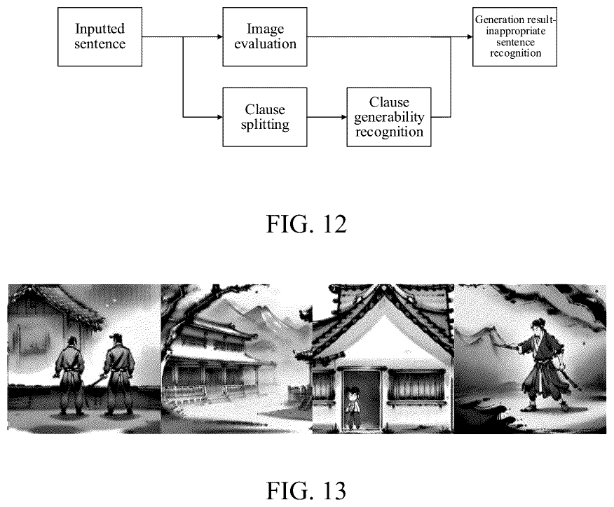

For some texts that are in an inputted sentence and that are inappropriate for illustration generation, for example, in a Chinese environment, it is difficult to perfectly present descriptive means, such as metaphors, parallelism, auxiliary words, and various actions in images, in this embodiment, related data is collected to train a sentence generability recognition model to recognize whether an inputted sentence is appropriate for generation. Referring to FIG. 12, FIG. 12 is a diagram of a process of generation result-inappropriate sentence recognition according to an embodiment of this application. For an inputted sentence, image evaluation is first performed on a generated image of the inputted sentence. A process of the image evaluation is a process of evaluating a similarity between the inputted sentence and the generated image. For a specific evaluation process, reference may be made to FIG. 10, and details are not described herein again. Next, the sentence generability recognition model is called to recognize whether an inputted sentence is appropriate for generation. In an image evaluation process, clause splitting is synchronously performed on the inputted sentence. After the clause splitting, clause generability recognition is performed.

The sentence generability recognition model is configured to determine whether a specific sentence is appropriate for an image generation model to generate an image.

In some embodiments, a text classification model may be trained as the sentence generability recognition model. The text classification model is configured to determine whether a text is appropriate for an image generation model to generate an image. Moreover, to determine whether a text is appropriate for image generation using the image generation model, it needs to determine whether annotated data can be generated based on the text by using the image generation model.

Specifically, text materials need to be prepared as training samples for training of the text classification model. First, sentence-level splitting is performed on texts of all novels, including performing period-level splitting to obtain S₁ sentences and performing comma-level splitting to obtain S₂ sentences. Therefore, a total of S₃ texts are obtained, S₃ being a sum of S₁ and S₂. The S₃ texts are inputted into the image generation model for generating corresponding generated images. 10 generated images are generated for each text under different random seeds (the random seed is configured for controlling the image generation model to generate, based on a subject style of a text, an image corresponding to the subject style). Therefore, a total of 10*S₃ generated images can be obtained. Next, two annotations are added to the generated images. An annotation 1 is configured to represent a degree of conformity between descriptive content of a generated image and descriptive content of a text, and an annotation 2 is configured to represent whether a text is an action description text. Details are described below.

With regard to the annotation 1, for S₃ texts, 10 generated images of each text are evaluated. Specifically, in 10 generated images corresponding to a text, if descriptive content of three or more generated images conforms to descriptive content of the text, the text is marked with 2, indicating that the text is appropriate for the image generation model to generate an image. If descriptive content of one or two generated images conforms to the descriptive content of the text, the text is marked with 1. If there is no generated image conforming to the descriptive content of the text, the text is marked as 0.

In some embodiments, a standard for determining whether descriptive content of a generated image conforms to the descriptive content of the text is as follows: Specific objects or elements (not including an abstract object or element) described in the text all appear, or when more than five specific objects or elements described in the text appear, 90% of the objects or elements appear.

For example, a descriptive element “ink” in a text “clothes are as black as ink” is an abstract object, and black clothes appearing in the generated image can be considered to conform to the described object of the text. In another example, in a text “The man walked into the alley with a box, stopped by a taxi next to a fruit stand, and talked to the driver through the half-open window of the taxi”, a total of seven elements “man, box, alley, fruit stand, taxi, window, driver” appear, and a generated image can be considered to conform to descriptive elements of the text only when at least six (that is, 7*90%) of the elements appear in the generated image.

For the annotation 2, it is directly determined whether each of the S₃ texts is an action description text, and if the text is an action description text, the text is marked with 1; otherwise, the text is marked with 0.

In some embodiments, a determining standard for determining whether a text is an action description text is to determine whether the text (sentence) includes a plurality of subtexts (clauses) to jointly describe an event or a scene.

For example, for a text “He pinched one end of the cotton thread with his dry left index finger and thumb, and slowly stretched out the head of the cotton thread toward the small needle eye under light, he didn't aim it the first time, the head of the cotton thread was crooked the second time, and the small fork at the head of the cotton thread blocked the needle eye the third time, and he tried again and again, and finally gave up”, it can be seen that a plurality of subtexts in the text are used to jointly describe a scene. Therefore, it can be determined that the text is an action description text.

Through the foregoing process, for the S₃ texts, the annotation 1 and the annotation 2 are generated for each text. The annotated texts can be used as training samples for training the text classification model. The text classification model includes two text classifiers, respectively configured to recognize whether content of a text is appropriate for illustration generation and whether the text is an action description text.

In some embodiments, the two text classifiers can be implemented by using a convolutional neural network and a multi-classification prediction layer. First, all the training samples carrying the annotation 1 and the annotation 2 are inputted into a BERT model for encoding, to obtain text encoding features of all the training sample. Then, the text encoding features of all the training samples are inputted into two convolutional neural networks each having a 1*1 convolution kernel for convolutional processing, and then, the obtained convolution features are inputted into the multi-classification prediction layer for prediction.

Structures of the two text classifiers are respectively shown in Table 1 and Table 2:

TABLE 1

| Layer name | Output size | Module |
|---|---|---|
| Input layer | 1 × 512 | 1 × 1 conv layer |
| Fusion layer | 1 × 1024 | 1 × 1 conv layer |
| Class 1 | 1 × 3 | 1 × 1 conv layer |

TABLE 2

| Layer name | Output size | Module |
|---|---|---|
| Input layer | 1 × 512 | 1 × 1 conv layer |
| Fusion layer | 1 × 1024 | 1 × 1 conv layer |
| Class2 | 1 × 2 | 1 × 1 conv layer |

It can be seen from the foregoing two tables that, a first layer of the model is an input layer, and a specific structure thereof is a convolutional neural network having a 1*1 convolution kernel. After text features of the training samples are inputted to the input layer of the model for convolutional processing, two convolutional text features with a size of 1*512 are outputted, and then the two outputted text features are further inputted to a second layer (fusion layer) of the model for convolutional processing, to output one convolutional text feature with a size of 1*1024. A specific structure of the fusion layer is a convolutional neural network having a convolution kernel of 1*1. Next, the convolutional text feature with a size of 1*1024 is inputted to the multi-classification prediction layer for prediction, an activation function of the prediction layer being a softmax function, and a predicted value outputted by the softmax function in the prediction layer is mapped into a one-hot form for output, that is, two classification prediction results are outputted, which are respectively Class1 and Class2 shown in the tables.

Because recognizing whether a text is appropriate for illustration generation is to perform determination based on a degree of conformity between descriptive content of an image generated based on the text and descriptive content of the text and corresponds to the annotation 1, and the annotation 1 has three annotation values “0, 1, 2”, predicted values (that is, Class1 in the foregoing tables) of the text classifier for the annotation 1 in the training sample are classified into three categories, and three-bit one-hots with a size of 1*3 are outputted. Similarly, because recognizing whether a text is an action description sentence is determining whether a plurality of subtexts (clauses) jointly describe an event or a scene, and corresponds to the annotation 2, and the annotation 2 has two annotation values “0, 1”, predicted values (that is, Class2 in the foregoing tables) of the text classifier for the annotation 2 in the training sample are classified into two categories, and two-bit one-hots with a size of 1*2 are outputted.

For example, if a Class1 prediction result outputted for a specific training sample is an annotation value 0, a predicted value of the first bit of a one-hot in the outputted Class1 is greater than 0.5, and predicted values of the second bit and the third bit of the one-hot are very small, so that a classification result finally outputted by the softmax function in the prediction layer may be represented as “100”. Similarly, if a Class1 prediction result outputted for a specific training sample is an annotation value 1, a predicted value of the second bit of a one-hot in the outputted Class1 is greater than 0.5, and predicted values of the first bit and the third bit of the one-hot are very small, so that a classification result finally outputted by the softmax function in the prediction layer may be represented as “010”. If a Class1 prediction result outputted for a specific training sample is an annotation value 2, a predicted value of the third bit of a one-hot in the outputted Class1 is greater than 0.5, and predicted values of the first bit and the second bit of the one-hot are very small, so that a classification result finally outputted by the softmax function in the prediction layer may be represented as “001”. In addition, if a Class2 prediction result outputted for a specific training sample is an annotation 0, a classification result finally outputted by the softmax function in the prediction layer may be represented as “10”. If a Class2 prediction result outputted for a specific training sample is an annotation 1, a classification result finally outputted by the softmax function in the prediction layer may be represented as “01”.

In some embodiments, all the training samples are inputted to the text classifier for training. A total of 60 iterations are performed in the training process. In each iteration, because video memory resources of a training machine are limited, all the training samples cannot be inputted at once to the text classifier for training. Therefore, all the training samples are used in batches for training, and every bs samples (batch_size) are inputted as one batch to update parameters of the text classifier. Specifically, a total of G/bs (G is a total quantity of training samples) parameter updates of the text classifier are performed for each iteration. That is, bs training samples in the G training samples are used each time without repetition for training prediction. Then, two classification cross-entropy loss functions are calculated. That is, after classification losses are calculated for all the training samples, the classification losses of all the training samples are averaged, to obtain a classification loss of each batch. Then, the loss functions are backhauled to the network of the text classifier by using a stochastic gradient descent algorithm, to update parameters of the network.

The classification cross-entropy loss function is expressed as follows:

$$L = \frac{1}{N} {\sum }_{i} {L}_{i} = \frac{1}{N} {\sum }_{i} - {\sum }_{c = 1}^{M} {y}_{ic} log ( {p}_{ic} ) \qquad ( 4 )$$

In the foregoing formula (4), p_{ic} represents a prediction probability that a prediction result of a training sample i belongs to a category c, y_{ic} represents whether a predicted annotation value of the sample i is c, and if the predicted annotation value of the sample i is c, y_{ic}=1; otherwise, y_{ic} is 0, N representing sample data, that is, batch_size, during each model update, M being a quantity of predicted categories, and if three-category prediction is performed, M being 3.

Still referring to FIG. 12, after training of the sentence generability recognition model is completed, the sentence generability recognition model can be configured for prediction, that is, recognition on an inputted sentence, to determine whether a current inputted sentence is an inappropriate sentence for image generation, and whether a further processing operation, such as deleting an inappropriate sentence for generation or splitting an inappropriate complex sentence for generation into clauses, needs to be performed. A process of calling the sentence generability recognition model to perform recognition on an inputted sentence includes two determination processes, that is, initial determination and further determination. Details are described below.

First, initial determination is performed. Inputted sentences are inputted to the sentence generability recognition model for recognition, so that the model can perform three-category classification on the inputted sentences, to obtain a classification predicted-value (a generability predicted-value) of each inputted sentence, that is, 0, 1, or 2, which corresponds to the annotation 1 during training of the sentence generability recognition model, and is configured to represent a degree to which the inputted sentence is appropriate for illustration generation. In addition, the sentence generability recognition model further predicts whether an inputted sentence is an action description sentence, to obtain a corresponding action predicted-value, that is, 0 or 1, which corresponds the annotation 2 for training the sentence generability recognition model and is configured to represent whether the inputted sentence is an action description sentence.

In some embodiments, a standard for the initial determination of the sentence generability recognition model is as follows: When a generability predicted-value of an inputted sentence is 0 or 1, it is determined that an image cannot be generated based on the inputted sentence, and the inputted sentence is deleted. When a generability predicted-value of an inputted sentence is 2 and a corresponding action predicted-value is 1, it is determined that a generation failure rate of the inputted sentence is high, and the inputted sentence also needs to be deleted. When a generability predicted-value of an inputted sentence is 2 and an action predicted-value is 0, and the inputted sentence includes a plurality of clauses, it is determined that the inputted sentence needs to be further processed, that is, clause splitting needs to be performed.

Referring to FIG. 12, in consideration of that many sentences in a Chinese environment all include a plurality of clauses that can be obtained through splitting by commas, a large quantity of sentences in inputted sentences need to be split into clauses. However, some consecutive clauses in the split sentences have similar descriptive content, and splitting is not needed. For example, for a sentence “The pine forest is endless, and large tracts of dark green pine trees extend to the horizon”, upon initial determination, although the sentence can be split into two clauses, the two clauses after the splitting have the same descriptive content, and even generated images may also be the same. Secondary splitting does not actually need to be performed on such a sentence. Therefore, for some inputted sentences, a result of the foregoing initial determination needs to be further determined, that is, clause generability recognition is performed on clauses split from the inputted sentence.

In some embodiments, a specific process of performing further determination on a clause split from an inputted sentence is as follows:

(1) After initial determination, an inputted sentence is split into a plurality of clauses, a generability recognition model is called to perform generability recognition on each split clause, to obtain a classification predicted-value (a generability predicted-value) of each clause, and a clause whose generability predicted-value is 2 is retained and is recorded as a generability clause.

For example, after initial determination is performed on an original inputted sentence, the original inputted sentence is split into 10 clauses, and then the generability recognition model is called to perform generability recognition on the 10 split clauses respectively, to obtain a generability predicted-value of each clause. Then, a clause with a generability predicted-value of 2 are retained and recorded as a generability clause. If there are five clauses with a generability predicted-value of 2, five generability clauses are determined.

(2) Each generability clause is denoted as i, and then, a similarity with the generability clause i is calculated in all generated images generated from the inputted sentence by calling the image generation model. For a process of calculating the similarity between the generability clause i and each generated image, reference may be made to FIG. 8, and details are not described herein again. Therefore, a similarity index between the generability clause i and each generated image may be obtained. Next, it is determined whether a maximum similarity index is greater than a similarity index threshold (denoted as thr₁). When the maximum similarity index is greater than the similarity index threshold thr₁, a generated image corresponding to the maximum similarity index is retained, denoted as j, and is matched with the generability clause i, to obtain an image-text pair, denoted as (i, j).

To follow the foregoing embodiment, a (cosine) similarity is separately calculated for each of the five generability clauses and all (for example, 10) generated images generated based on the inputted sentence. Therefore, 10 similarity indexes may be obtained for each generability clause. Then, it is determined whether a maximum one of the 10 similarity indexes is greater than an image-text similarity threshold thr₁. If the maximum similarity index is greater than the similarity threshold thr₁, a generated image corresponding to the maximum similarity index is matched with the generability clause to obtain an image-text pair. If the similarity index is not greater than the similarity threshold thr₁, the 10 similarity indexes are all less than the similarity threshold thr₁, and no corresponding generated image can be found for the generability clause.

(3) According to operation (2), a plurality of image-text pairs (i, j) can be obtained from all the generability clauses i while meeting the condition of the similarity index threshold thr₁.

To follow the foregoing embodiment, after corresponding image-text pairs can be found from generated images of the inputted sentence for all the five generability clauses, finally, corresponding generated images are found for only four generability clauses, and the four generability clauses correspond to the four generated images. That is, there are a total of four image-text pairs.

(4) Variance calculation is performed on the corresponding generated images in the image-text pairs (i, j). A variance is configured to represent a feature similarity of a plurality of images. Comparison of similarities of the generated images is to compare degrees of the generated images being close to the variance. A smaller variance difference indicates that the images are more similar. When the variance is greater than a variance threshold thr₂, generability clauses corresponding to the generated images are greatly different, and need to be further split for generation.

For example, referring to FIG. 13, FIG. 13 is a diagram of determining a difference between generated images according to an embodiment of this application. For four image-text pairs, four generability clauses are specifically described as “The two people walked for a long time, it was almost dawn when they arrived at the small hotel at the foot of the mountain, they woke up the shopkeeper by the door, and the young man in red showed the sword in his hand to the shopkeeper”, and four corresponding generated images are shown in FIG. 13. By performing variance calculation on the four images, it is found that the variance is greater than a variance threshold, and the generated images have completely different presented content, and finally, it is determined that the inputted sentence needs to be split for splitting.

In some embodiments, a method for calculating a variance of a plurality of generated images may be first calculating a variance of each generated image and then determining a total variance of the plurality of generated images. A specific calculation process is as follows: Grayscale processing is first performed on each generated image, to obtain a corresponding grayscale image. For a grayscale image of each generated image, average values of grayscale values of all rows of pixels of the generated image are sequentially calculated respectively, and variance calculation is performed on all the obtained average values, so that an obtained variance result is an eigenvalue of the generated image. After an eigenvalue (variance) is calculated for each generated image, the eigenvalues are compared with each other to determine a difference between variances of any two generated images, and a variance with a maximum variance difference is used as a total variance of the plurality of generated images.

In some embodiments, a method for calculating a variance of a plurality of generated images may alternatively be directly calculating variances of the plurality of images. A specific calculation process is as follows: Grayscale processing is first performed on each generated image to obtain a grayscale image, a sum of grayscale values of all pixels of each grayscale image is determined, and then a variance of a sum of the grayscale values are directly calculated as a variance of the plurality of generated images.

In some embodiments, a method for determining the similarity index threshold thr₁ may be obtained by searching recall rates calculated based on a large quantity of image-text pairs. Specifically, a specific quantity of (for example, 10000) image-text pairs are collected, then threshold points are set from 0 to 1 with 0.1 as a unit stride, and then similarity indexes of each of the 10000 image-text pairs are calculated separately at different threshold points. For a specific method for calculating the similarity index, reference may be made to an image-text similarity calculation process shown in FIG. 8, and details are not described herein again. Then, a quantity of image-text pairs having a similarity index greater than a threshold point in the image-text pairs is counted, to determine a proportion of the quantity of the image-text pairs having a similarity index greater than the threshold point to a total quantity of image-text pairs (10000 image-text pairs), and use the proportion as a recall rate at the corresponding threshold point. When a recall rate at a threshold point reaches 80%, a search process is stopped, and the threshold point at this time is used as a similarity index threshold thr₁.

In some embodiments, a method for determining a variance threshold thr₂ may be obtained based on the similarity index threshold thr₁. When the similarity index threshold thr₁ is determined, image-text pairs having a similarity index greater than the similarity index threshold thr₁ in the 10000 image-text pairs are determined, and a variance of corresponding images in the image-text pairs is calculated, and used as the variance threshold thr₂.

For example, when a set threshold point is 0.6, a similarity index of each of 10000 image-text pairs is calculated. Then, a quantity of image-text pairs having a similarity index greater than the threshold point in the image-text pairs is counted to 8000, and a proportion of the quantity of the image-text pairs having a similarity index greater than the threshold point to the total quantity of image-text pairs (10000 image-text pairs) is determined to be 80%. In this case, the search is stopped, and 0.6 is used as the similarity index threshold thr₁. Then, based on the similarity index threshold thr₁, variances of corresponding images in the 8000 image-text pairs are calculated, that is, variances of the 8000 images are calculated, and a finally calculated variance result is used as the variance threshold thr₁.

Still referring to FIG. 12, after further determination is performed on clauses split from the inputted sentence, that is, after clause generability recognition is completed, the sentence generability recognition model completes generation result-inappropriate sentence recognition on the inputted sentence, and may determine generated images of which inputted sentences in the inputted sentences need to be retained, which inputted sentences inappropriate for illustration generation in the inputted sentences need to be deleted, and which sentences inappropriate for illustration generation need to be split for image re-generation.

Still referring to FIG. 4, after the sentence generability recognition model is called to perform generation result-inappropriate sentence recognition on inputted sentences (the sentence 1, the sentence 2, and the sentence 3), “Retain the sentence 1”, “Split the sentence 2”, “Delete the sentence 3”, and so on can be determined. For “Split the sentence 2”, the sentence 2 “At the small hotel at the foot of the mountain, it was almost dawn when the two arrived, and the young man woke the owner up from the bed without thinking twice, threw out a large ingot of silver, and asked for pheasant and mushroom soup” is split into three clauses: “At the small hotel at the foot of the mountain”, “it was almost dawn when the two arrived”, and “the young man asked for pheasant and mushroom soup”. The image generation model is further called to perform secondary generation on the three clauses separately, and generation result sequencing is performed on generated images corresponding to the three clauses, to obtain corresponding three generated images as a finally image sequence of the sentence 2.

Therefore, the system automatically drives the image generation model to perform secondary generation. For sentences that can be split, after the image generation model is called for secondary image generation, it is further determined whether generation is inappropriate until it is recognized that no sentence is inappropriate for generation, generation result sequencing is then performed to obtain images, and the images of the sentences are retained and combined with images secondarily generated from clauses that can be split, to finally obtain an image sequence of all the sentences.

Through this embodiment, a closed-loop generation system is constructed according to generation-text to image generability, recognized generability evaluation, and re-generation after adjustment on a sentence for generation, to automatically split and delete a description of a novel script, to screen sentences or long sentences inappropriate for image generation, split the long sentences to obtain a plurality of clauses, then perform finer-grained secondary image generation on the clauses, and perform sequencing to select images, thereby implementing properness evaluation on prompts at a clause granularity and fine-grained image selection without manual interaction for each time of image selection. Problems, such as improper generation of an image from words of a prompt and missing of a generation element in a generated image, can be effectively resolved, thereby improving a relevance of an overall image generation effect. Moreover, during image selection, a historically generated sequence element library is constructed, and the sequence element library constructed through zero-sample denoising is used as a reference, and the generated images are re-sorted based on consistency of noun elements to obtain a final sorting result, thereby avoiding a problem of inconsistency between consecutive image elements in a generation re-sorting result based on a sequence relevance of a prompt.

A structure of an image processing apparatus 453 that is implemented as a software module and that is provided in this embodiment is further described below. In some embodiments, as shown in FIG. 2, a software module in the image processing apparatus 453 stored a memory 450 may include: an obtaining module 4531, configured to obtain a prompt that needs to be processed; a mapping module 4533, configured to obtain a text feature of the prompt that needs to be processed, and map the text feature to a generability index and a description type of the prompt that needs to be processed, the generability index being configured to represent a score of an illustration being generable from the prompt that needs to be processed, the obtaining module 4531 being further configured to: in response to the generability index being greater than an index threshold, the description type representing that the prompt that needs to be processed does not include a verb, and the prompt that needs to be processed including a plurality of clauses, obtain similar images respectively corresponding to the plurality of clauses, image-text similarities between the clauses and the corresponding similar images being greater than an image-text similarity threshold; and a determining module 4532, configured to determine an image difference between the similar images respectively corresponding to the plurality of clauses, the determining module 4532 being further configured to: in response to the image difference being less than an image difference threshold, use the similar images respectively corresponding to the plurality of clauses as illustrations of the corresponding clauses.

In some embodiments, the determining module 4532 is further configured to: in response to the image difference being greater than or equal to the image difference threshold, further split the plurality of clauses into a plurality of new prompts that need to be processed.

In some embodiments, the obtaining module 4531 is further configured to: convert a prompt that needs to be processed into a tag sequence, and call a semantic understanding model based on the tag sequence to perform encoding, to obtain the text feature of the prompt that needs to be processed.

In some embodiments, the obtaining module 4531 is further configured to: call a convolutional network in a first text classifier to perform a convolution operation on at least one noun element, to obtain a first convolution feature, call a multi-classification layer in the first text classifier to map the first convolution feature to first probabilities of a plurality of candidate generability indexes, and use a candidate generability index corresponding to a maximum first probability as the generability index of the prompt that needs to be processed, the generability index being configured to represent a score of an illustration being generable from the prompt that needs to be processed; and call a convolutional network in a second text classifier to perform a convolution operation on the at least one noun element, to obtain a second convolution feature, call the multi-classification layer in the first text classifier to map the second convolution feature to second probabilities of a plurality of description types, and use a description type corresponding to a maximum second probability as the description type of the prompt that needs to be processed, the description type including: verb-included and verb-excluded.

In some embodiments, the obtaining module 4531 is further configured to delete the prompt that needs to be processed in response to the generability index being greater than the index threshold and the description type representing that the prompt that needs to be processed includes a verb.

In some embodiments, the obtaining module 4531 is further configured to: in response to the generability index being less than or equal to the index threshold, store illustrations of prompts that need to be processed into an illustration sequence of a text in an order of generation, the different prompts that need to be processed being sequentially extracted from the text.

In some embodiments, the determining module 4532 is further configured to perform the following processing for each similar image: determining grayscale average values of all rows of pixels in the similar image, and combining the grayscale average values of all the rows of pixels into an image feature of the similar image; and determine a variance of image features of the similar images respectively corresponding to the plurality of clauses, and use the variance as the image difference between the similar images respectively corresponding to the plurality of clauses.

In some embodiments, the determining module 4532 is further configured to obtain an image-text pair sample set, the image-text pair sample set including a plurality of image-text pairs, the image-text pair including a sample prompt and a sample similar image; determine a recall rate of the image-text pair sample set at a current threshold point in ascending order of a plurality of preset threshold points, the recall rate being a ratio of the following two: a quantity of recalled image-text pairs and a total quantity of the plurality of image-text pairs, an image-text similarity between the sample prompt and the sample similar image in the recalled image-text pair being greater than or equal to the current threshold point; determine the current threshold point as the image-text similarity threshold in response to the recall rate at the current threshold point being greater than or equal to a recall rate threshold; determine a variance of image features of sample similar images in the recalled image-text pairs, and use the variance of the image features of the sample similar images in the recalled image-text pairs as the image difference threshold

In some embodiments, the obtaining module 4531 is further configured to: in response to the prompt that needs to be processed being an appropriate sentence, obtain a plurality of generated images of the prompt that needs to be processed, determine an illustration of the prompt that needs to be processed from the plurality of generated images, and store the illustration of the prompt that needs to be processed, the appropriate sentence being a sentence that does not meet an inappropriate-sentence condition, the inappropriate-sentence condition including at least one of the following: the generability index is greater than the index threshold, the description type represents that the prompt that needs to be processed does not include a verb, and the prompt that needs to be processed includes a plurality of clauses; the image difference is greater than or equal to the image difference threshold; and the generability index is greater than the index threshold, and the description type represents that the prompt that needs to be processed includes a verb.

In some embodiments, the determining module 4532 is further configured to: determine image-text similarities respectively between the plurality of generated images and the prompt that needs to be processed, and use a generated image corresponding to an image-text similarity greater than the image-text similarity threshold as a retained image; in response to the retained image including a noun element in the prompt that needs to be processed and at least one historical element in a database including the noun element, query the database for a historical element feature of the noun element; determine an element similarity between the retained image and the historical element feature, query the database for an image feature of a historical illustration of a historical prompt, and determine an image similarity between the retained image and the historical illustration based on the image feature of the historical illustration and an image feature of the retained image; perform weighted summation on the element similarity and the image similarity to obtain a total fusion score of the retained image; and determine a retained image corresponding to a maximum total fusion score as the illustration of the prompt that needs to be processed.

In some embodiments, the determining module 4532 is further configured to obtain image features respectively corresponding to the plurality of generated images; recognize a noun element in the prompt that needs to be processed, and encode the noun element, to obtain a prompt element feature; and perform the following processing on each generated image: determining a cosine similarity between the image feature of the generated image and the prompt element feature, and use the cosine similarity as the image-text similarity between the generated image and the prompt that needs to be processed.

In some embodiments, the determining module 4532 is further configured to: determine image-text similarities respectively between the plurality of generated images and the prompt that needs to be processed, and use a generated image corresponding to a maximum image-text similarity as the illustration of the prompt that needs to be processed.

In some embodiments, the determining module 4532 is further configured to recognize a common element between the retained image and the noun element; query the database for a historical element feature corresponding to the common element, the database including the feature of the historical element in the historical prompt.

In some embodiments, the determining module 4532 is further configured to determine element similarities between the retained image and different types of historical element features, the types of the historical element features including: a character, an environment, and a prop; and perform weighted summation on the element similarities between the retained image and the different types of historical element features, to obtain the element similarity between the retained image and the historical element feature.

In some embodiments, the determining module 4532 is further configured to use a noun element in the prompt that needs to be processed as the historical element, and store the historical element and a corresponding historical element feature into the database; and use the illustration of the prompt that needs to be processed as a historical image, and store the historical image into the database.

In some embodiments, the determining module 4532 is further configured to: when the prompt that needs to be processed is a non-first prompt extracted from the text, update the database in the following manner: performing weighted summation on an element feature of a noun element appearing in the retained image and a historical element feature of a historical element having a same name in the database, to replace the historical element feature before the update with an obtained updated historical element feature; and perform weighted summation on the image feature of the retained image and the image feature of the historical illustration in the database, and replace the image feature before update with the obtained updated image feature.

In some embodiments, the obtaining module 4531 is further configured to encode the prompt that needs to be processed, to obtain a text feature of the prompt that needs to be processed and an image feature corresponding to the text feature of the prompt that needs to be processed;
perform noise addition on the image feature, to obtain a noise image feature; fuse the text feature and the noise image feature, to obtain a fused feature; denoise the fused feature, to obtain a restored image feature; and decode the restored image feature, to obtain a plurality of generated images.

An embodiment of this application provides a computer program product, including computer-executable instructions or a computer program, the computer-executable instructions or the computer program being stored in a computer-readable storage medium. A processor of an electronic device reads the computer-executable instructions or the computer program from the computer-readable storage medium. The processor executes the computer-executable instructions or the computer program, to cause the electronic device to perform the foregoing image processing method in the embodiments of this application.

An embodiment of this application provides a computer-readable storage medium having computer-executable instructions or a computer program stored therein. When executed by a processor, the computer-executable instructions or the computer program causes the processor to perform the image processing method provided in the embodiments of this application, for example, the image processing method shown in FIG. 3A to FIG. 3K.

In some embodiments, the computer-readable storage medium may be a memory such as a RAM, a ROM, a flash memory, a magnetic surface memory, an optical disk, or a CD-ROM, or may be various devices including one or any combination of the foregoing memories.

In some embodiments, the computer-executable instructions may be written in any form of programming language (including a compiled or interpreted language, or a declarative or procedural language) by using the form of a program, software, a software module, a script or code, and may be deployed in any form, including being deployed as an independent program or being deployed as a module, a component, a subroutine, or another unit suitable for use in a computing environment.

In one embodiment, the computer-executable instructions may be deployed for execution on one electronic device, execution on a plurality of electronic devices located at one location, or execution on a plurality of electronic devices that are distributed at a plurality of locations and that are interconnected through a communication network.

In conclusion, based on selecting illustrations from generated images of prompts for the first time, according to descriptions of the prompts and the generated images, prompts with poor illustration quality are automatically recognized by using a sentence generability recognition model with reference to a generated-image distribution status, and processing feedback is provided. Specifically, by performing generability evaluation on the prompts and determining description types of the prompts, it can be recognized whether a prompt is a detailed description action and whether the prompt is appropriate for illustration generation. Then, the prompt that needs to be processed is automatically split or deleted, sentences or long sentences inappropriate for image generation are screened, the long sentences are split to obtain a plurality of clauses, then finer-grained secondary image generation are performed on the clauses, and sequencing is performed to select images. Not only problems, such as single-time image generation of the prompt and missing of a generation element in the generated image, can be effectively resolved, but also properness evaluation on the prompt that needs to be processed at a clause granularity and finer-grained image selection can be implemented, so that the generated image is more proper, and correlation of an overall generation result of the prompt that needs to be processed is improved. Moreover, during image selection, a historically generated sequence element library is constructed, and the sequence element library constructed through zero-sample denoising is used as a reference, and the generated images are re-sorted based on consistency of noun elements to obtain a final sorting result, thereby resolving a problem of inconsistency between consecutive image elements in a generation re-sorting result based on a sequence relevance of a prompt.

The foregoing descriptions are merely embodiments of this application and are not intended to limit the protection scope of this application. Any modification, equivalent replacement, or improvement made without departing from the spirit and range of this application shall fall within the protection scope of this application.

What is claimed is:

1. An image processing method, performed by an electronic device, the method comprising:
receiving a prompt that needs to be processed;
obtaining a text feature of the prompt, and mapping the text feature to a generability index and a description type of the prompt, the generability index representing a score of an illustration being generable from the prompt;
in response to the generability index being greater than an index threshold, the description type representing that the prompt does not comprise a verb, and the prompt comprising a plurality of clauses, obtaining similar images respectively corresponding to the plurality of clauses, image-text similarities between the clauses and the corresponding similar images being greater than an image-text similarity threshold;
determining an image difference between the similar images respectively corresponding to the plurality of clauses; and
in response to the image difference being less than an image difference threshold, using the similar images respectively corresponding to the plurality of clauses as illustrations of the corresponding clauses.

2. The method according to claim 1, further comprising:
in response to the image difference being greater than or equal to the image difference threshold, further splitting the plurality of clauses into a plurality of new prompts that need to be processed.

3. The method according to claim 1, wherein
the obtaining a text feature of the prompt that needs to be processed comprises:
converting the prompt into a tag sequence; and
calling a semantic understanding model based on the tag sequence to perform encoding, to obtain the text feature of the prompt; and
the mapping the text feature to a generability index and a description type of the prompt that needs to be processed comprises:
calling a convolutional network in a first text classifier to perform a convolution operation on the text feature, to obtain a first convolution feature, calling a multi-classification layer in the first text classifier to map the first convolution feature to first probabilities of a plurality of candidate generability indexes, and using a candidate generability index corresponding to a maximum first probability as the generability index of the prompt; and
calling a convolutional network in a second text classifier to perform a convolution operation on the text feature, to obtain a second convolution feature, calling the multi-classification layer in the first text classifier to map the second convolution feature to second probabilities of a plurality of description types, and using a description type corresponding to a maximum second probability as the description type of the prompt, the description type comprising: verb-included and verb-excluded.

4. The method according to claim 1, further comprising:
deleting the prompt in response to the generability index being greater than the index threshold and the description type representing that the prompt comprises a verb.

5. The method according to claim 1, further comprising:
in response to the generability index being less than or equal to the index threshold, storing illustrations of prompts into an illustration sequence of a text in an order of generation, the different prompts being sequentially extracted from the text

6. The method according to claim 1, wherein
the determining an image difference between the similar images respectively corresponding to the plurality of clauses comprises:
performing the following processing for each similar image:
determining grayscale average values of all rows of pixels in the similar image, and combining the grayscale average values of all the rows of pixels into an image feature of the similar image; and
determining a variance of image features of the similar images respectively corresponding to the plurality of clauses, and using the variance as the image difference between the similar images respectively corresponding to the plurality of clauses.

7. The method according to claim 6, further comprising:
obtaining an image-text pair sample set, the image-text pair sample set comprising a plurality of image-text pairs, the image-text pair comprising a sample prompt and a sample similar image;
determining a recall rate of the image-text pair sample set at a current threshold point in ascending order of a plurality of preset threshold points, the recall rate being a ratio of the following two: a quantity of recalled image-text pairs and a total quantity of the plurality of image-text pairs, an image-text similarity between the sample prompt and the sample similar image in the recalled image-text pair being greater than or equal to the current threshold point;
determining the current threshold point as the image-text similarity threshold in response to the recall rate at the current threshold point being greater than or equal to a recall rate threshold; and
determining a variance of image features of sample similar images in the recalled image-text pairs, and using the variance of the image features of the sample similar images in the recalled image-text pairs as the image difference threshold.

8. The method according to claim 1, further comprising:
in response to the prompt that needs to be processed being an appropriate sentence, obtaining a plurality of generated images of the prompt, determining an illustration of the prompt from the plurality of generated images, and storing the illustration of the prompt, the appropriate sentence being a sentence that does not meet an inappropriate-sentence condition, the inappropriate-sentence condition comprising at least one of the following: the generability index is greater than the index threshold, the description type represents that the prompt does not comprise a verb, and the prompt comprises a plurality of clauses; the image difference is greater than or equal to the image difference threshold; and the generability index is greater than the index threshold, and the description type represents that the prompt comprises a verb.

9. The method according to claim 8, wherein
when the prompt that needs to be processed is a non-first prompt extracted from the text, the determining an illustration of the prompt from the plurality of generated images comprises:
determining image-text similarities respectively between the plurality of generated images and the prompt, and using a generated image corresponding to an image-text similarity greater than the image-text similarity threshold as a retained image;
in response to the retained image comprising a noun element in the prompt and at least one historical element in a database comprising the noun element, querying the database for a historical element feature of the noun element;
determining an element similarity between the retained image and the historical element feature, querying the database for an image feature of a historical illustration of a historical prompt, and determining an image similarity between the retained image and the historical illustration based on the image feature of the historical illustration and an image feature of the retained image;
performing weighted summation on the element similarity and the image similarity to obtain a total fusion score of the retained image; and
determining a retained image corresponding to a maximum total fusion score as the illustration of the prompt.

10. The method according to claim 9, wherein the determining image-text similarities between the plurality of generated images and the prompt comprises:
obtaining image features respectively corresponding to the plurality of generated images;
recognizing a noun element in the prompt, and encoding the noun element, to obtain a prompt element feature; and
performing the following processing on each generated image: determining a cosine similarity between the image feature of the generated image and the prompt element feature, and using the cosine similarity as the image-text similarity between the generated image and the prompt.

11. The method according to claim 9, wherein
when the prompt is a first prompt extracted from the text, the determining an illustration of the prompt from the plurality of generated images comprises:
determining image-text similarities respectively between the plurality of generated images and the prompt, and using a generated image corresponding to a maximum image-text similarity as the illustration of the prompt.

12. The method according to claim 9, wherein
the historical element feature is a feature of the historical element in the historical prompt; and
the querying the database for a historical element feature of the noun element comprises:
recognizing a common element between the retained image and the noun element; and
querying the database for a historical element feature corresponding to the common element, the database comprising the feature of the historical element in the historical prompt.

13. The method according to claim 9, wherein the determining an element similarity between the retained image and the historical element feature comprises:
determining element similarities between the retained image and different types of historical element features, the types of the historical element features comprising: a character, an environment, and a prop; and
performing weighted summation on the element similarities between the retained image and the different types of historical element features, to obtain the element similarity between the retained image and the historical element feature.

14. The method according to claim 9, further comprising:
when the prompt is a first prompt extracted from the text, updating the database in the following manner:
using a noun element in the prompt as the historical element, and storing the historical element and a corresponding historical element feature into the database; and
using the illustration of the prompt as a historical image, and storing the historical image into the database.

15. The method according to claim 9, further comprising:
when the prompt is a non-first prompt extracted from the text, updating the database in the following manner:
performing weighted summation on an element feature of a noun element appearing in the retained image and a historical element feature of a historical element having a same name in the database, to replace the historical element feature before the update with an obtained updated historical element feature; and
performing weighted summation on the image feature of the retained image and the image feature of the historical illustration in the database, and replacing the image feature before update with the obtained updated image feature.

16. The method according to claim 1, wherein the obtaining a plurality of generated images of the prompt that needs to be processed comprises:
encoding the prompt, to obtain a text feature of the prompt and an image feature corresponding to the text feature of the prompt;
performing noise addition on the image feature, to obtain a noise image feature;
fusing the text feature and the noise image feature, to obtain a fused feature;
denoising the fused feature, to obtain a restored image feature; and
decoding the restored image feature, to obtain a plurality of generated images.

17. An electronic device, comprising:
a memory, configured to store computer-executable instructions or a computer program; and
a processor, configured to implement, when executing the computer-executable instructions or the computer program stored in the memory, an image processing method, performed by an electronic device, the method comprising:
receiving a prompt that needs to be processed;
obtaining a text feature of the prompt, and mapping the text feature to a generability index and a description type of the prompt, the generability index representing a score of an illustration being generable from the prompt;
in response to the generability index being greater than an index threshold, the description type representing that the prompt does not comprise a verb, and the prompt comprising a plurality of clauses, obtaining similar images respectively corresponding to the plurality of clauses, image-text similarities between the clauses and the corresponding similar images being greater than an image-text similarity threshold;
determining an image difference between the similar images respectively corresponding to the plurality of clauses; and
in response to the image difference being less than an image difference threshold, using the similar images respectively corresponding to the plurality of clauses as illustrations of the corresponding clauses.

18. The electronic device according to claim 17, wherein the method further comprising:
in response to the image difference being greater than or equal to the image difference threshold, further splitting the plurality of clauses into a plurality of new prompts.

19. The electronic device according to claim 17, wherein
the obtaining a text feature of the prompt that needs to be processed comprises:
converting the prompt into a tag sequence; and
calling a semantic understanding model based on the tag sequence to perform encoding, to obtain the text feature of the prompt; and
the mapping the text feature to a generability index and a description type of the prompt comprises:
calling a convolutional network in a first text classifier to perform a convolution operation on the text feature, to obtain a first convolution feature, calling a multi-classification layer in the first text classifier to map the first convolution feature to first probabilities of a plurality of candidate generability indexes, and using a candidate generability index corresponding to a maximum first probability as the generability index of the prompt; and
calling a convolutional network in a second text classifier to perform a convolution operation on the text feature, to obtain a second convolution feature, calling the multi-classification layer in the first text classifier to map the second convolution feature to second probabilities of a plurality of description types, and using a description type corresponding to a maximum second probability as the description type of the prompt, the description type comprising: verb-included and verb-excluded.

20. A non-transitory computer-readable storage medium, having computer-executable instructions or a computer program stored therein, the computer-executable instructions or the computer program, when executed by a processor, implementing an image processing method, performed by an electronic device, the method comprising:
receiving a prompt that needs to be processed;
obtaining a text feature of the prompt, and mapping the text feature to a generability index and a description type of the prompt, the generability index representing a score of an illustration being generable from the prompt;
in response to the generability index being greater than an index threshold, the description type representing that the prompt does not comprise a verb, and the prompt comprising a plurality of clauses, obtaining similar images respectively corresponding to the plurality of clauses, image-text similarities between the clauses and the corresponding similar images being greater than an image-text similarity threshold;
determining an image difference between the similar images respectively corresponding to the plurality of clauses; and
in response to the image difference being less than an image difference threshold, using the similar images respectively corresponding to the plurality of clauses as illustrations of the corresponding clauses.
